(19) United States
(12) Patent Application Publication
(10) Pub. No.: US 2025/0385761 A1
(43) Pub. Date: Dec. 18, 2025

(54) UDC BUFFER ERROR RESOLUTION OPERATIONS

(71) Applicant: QUALCOMM Incorporated, San Diego, CA (US)

(72) Inventors: Ruiming Zheng, Beijing (CN); Ozcan Ozturk, San Diego, CA (US)

(21) Appl. No.: 18/878,758

(22) PCT Filed: Aug. 19, 2022
(86) PCT No.: PCT/CN2022/113591

§ 371 Date: Dec. 24, 2024

(51) Int. Cl. H04L 1/1867; H04L 1/1812

(52) U.S. Cl. CPC H04L 1/1874; H04L 1/1816

(57) ABSTRACT

This disclosure provides systems, methods, and devices for wireless communication that supports buffer error resolution operations. In a first aspect, a device transmits first PDUs, each PDU corresponding to a respective SDU of first SDUs; receives a buffer error indication and an indication of a serial number of a particular PDU processed by another device, the first PDUs include the particular PDU; generates second PDUs, wherein each PDU of the second PDUs corresponds to a respective SDU of second SDUs, wherein each PDU of the second PDUs is a respective compressed PDU corresponding to a respective PDU of a subset of PDUs of the first PDUs which are associated with a respective serial number equal to or greater than the serial number of the particular PDU; and transmits the second PDUs to the second network node. Other aspects and features are also claimed and described.

### TECHNICAL FIELD

Aspects of the present disclosure relate generally to wireless communication systems, and more particularly, to buffer error resolution operations. Some features may enable and provide improved communications, including improved UDC (uplink data compression) buffer error resolution operations.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, an apparatus includes at least one processor and a memory coupled to the at least one processor. The at least one processor is configured to: cause transmission of a first plurality of Packet Data Convergence Protocol (PDCP) Protocol Data Units (PDUs), wherein each PDCP PDU of the first plurality of PDCP PDUs corresponds to a respective PDCP Service Data Unit (SDU) of a first plurality of PDCP SDUs; receive, from a second network node, an uplink data compression (UDC) buffer error indication and an indication of a serial number of a particular PDCP PDU processed by the second network node, wherein the first plurality of PDCP PDUs includes the particular PDCP PDU, wherein the UDC buffer error indication is indicative of an error corresponding to the transmission of the first plurality of PDCP PDUs; generate, based on the serial number of the particular PDCP PDU, a second plurality of PDCP PDUS, wherein each PDCP PDU of the second plurality of PDCP PDUs corresponds to a respective PDCP SDU of a second plurality of PDCP SDUs, wherein each PDCP PDU of the second plurality of PDCP PDUs is a respective compressed PDCP PDU corresponding to a respective PDCP PDU of a subset of PDCP PDUs of the first plurality of PDCP PDUs which are associated with a respective serial number equal to or greater than the serial number of the particular PDCP PDU; and cause transmission of the second plurality of PDCP PDUs to the second network node.

In an additional aspect of the disclosure, an apparatus includes at least one processor and a memory coupled to the at least one processor. The at least one processor is configured to: receive a first plurality of Packet Data Convergence Protocol (PDCP) Protocol Data Units (PDUs), wherein each PDCP PDU of the first plurality of PDCP PDUs corresponds to a respective PDCP Service Data Unit (SDU) of a first plurality of PDCP SDUs; transmit, to a second network node, an uplink data compression (UDC) buffer error indication and an indication of a serial number of a particular PDCP PDU processed by the first network node, wherein the UDC buffer error indication is indicative of an error corresponding to the reception of the first plurality of PDCP PDUs; receive a second plurality of PDCP PDUs from the second network node, wherein each PDCP PDU of the second plurality of PDCP PDUs corresponds to a respective PDCP SDU of a second plurality of PDCP SDUs, wherein each PDCP PDU of the second plurality of PDCP PDUs is a respective compressed PDCP PDU corresponding to a respective PDCP PDU of a subset of PDCP PDUs of the first plurality of PDCP PDUs which are associated with a respective serial number equal to or greater than the serial number of the particular PDCP PDU; and generate, based on the serial number of the particular PDCP PDU, the PDCP SDUs of the second plurality of PDCP SDUs from the second plurality of PDCP PDUs, wherein the generated second plurality of PDCP SDUs are uncompressed PDCP SDUs.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3A is a timing diagram illustrating an example of buffer error resolution according to one or more aspects.

FIG. 3B is a block diagram illustrating an example of downlink layer 2 structure according to one or more aspects.

FIG. 3C is a block diagram illustrating an example of uplink layer 2 structure according to one or more aspects.

FIG. 3D is a block diagram illustrating an example of a control PDU according to one or more aspects.

FIG. 3E is a timing diagram illustrating an example wireless communication system that supports selective retransmission according to one or more aspects.

FIG. 4 is a block diagram illustrating an example wireless communication system that supports buffer error resolution operations according to one or more aspects.

FIG. 5 is a flow diagram illustrating an example process that supports buffer error resolution operations according to one or more aspects.

FIGS. 6A and 6B are block diagrams illustrating buffer operations that support buffer error resolution operations according to one or more aspects.

FIG. 7 is a timing diagram illustrating an example wireless communication system that supports buffer error resolution operations according to one or more aspects.

FIG. 8 is a block diagram illustrating buffer operations that support buffer error resolution operations according to one or more aspects.

FIG. 9 is a flow diagram illustrating an example process that supports buffer error resolution operations according to one or more aspects.

FIG. 10 is a flow diagram illustrating an example process that supports buffer error resolution operations according to one or more aspects.

FIG. 11 is a block diagram of an example UE that supports buffer error resolution operations according to one or more aspects.

FIG. 12 is a block diagram of an example base station that supports buffer error resolution operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

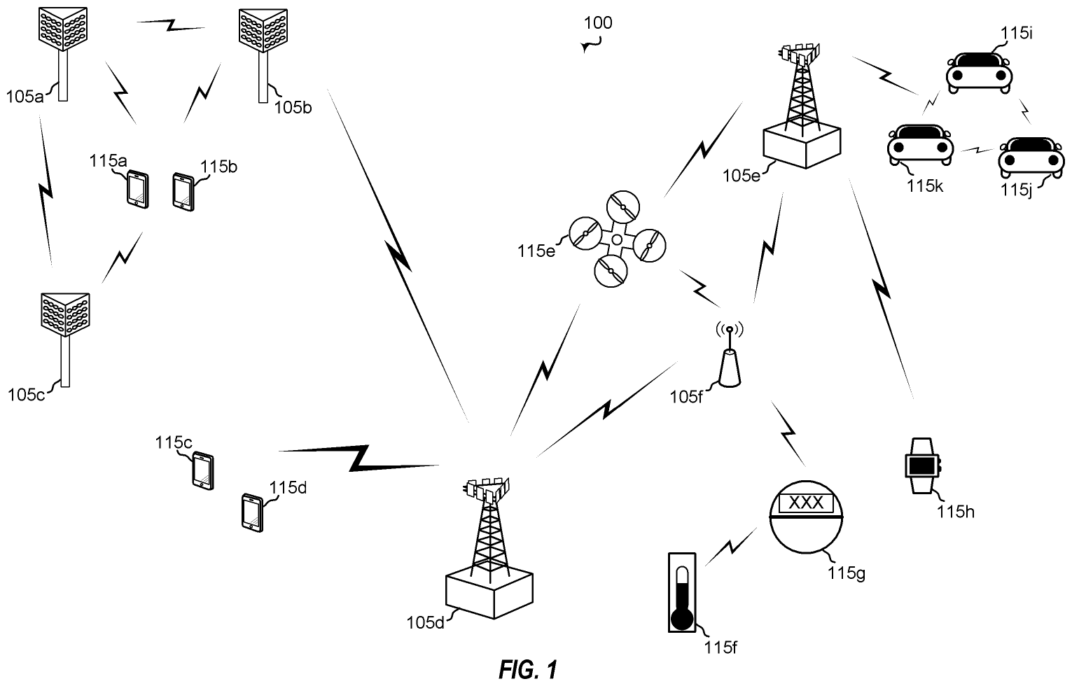

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

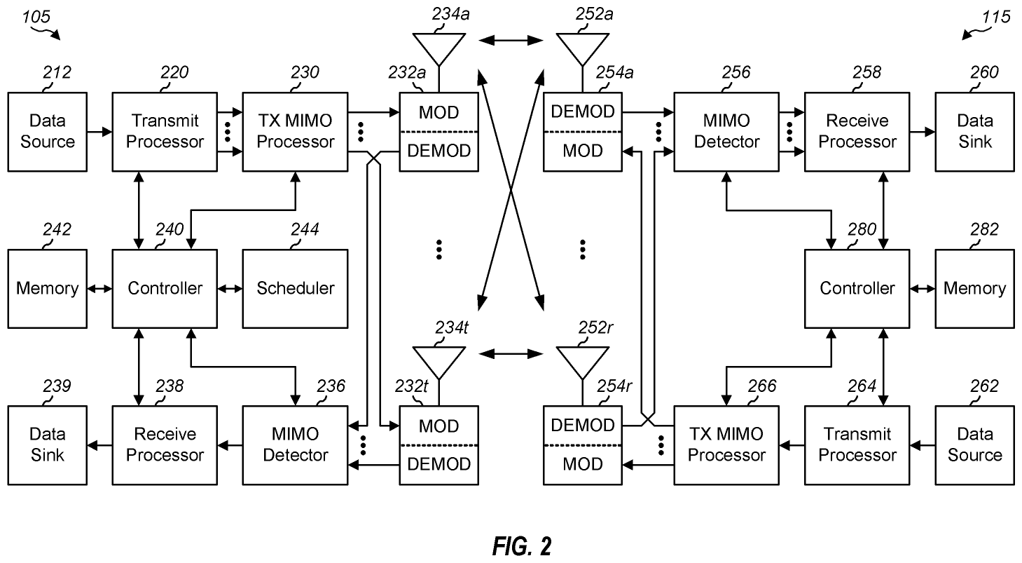

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

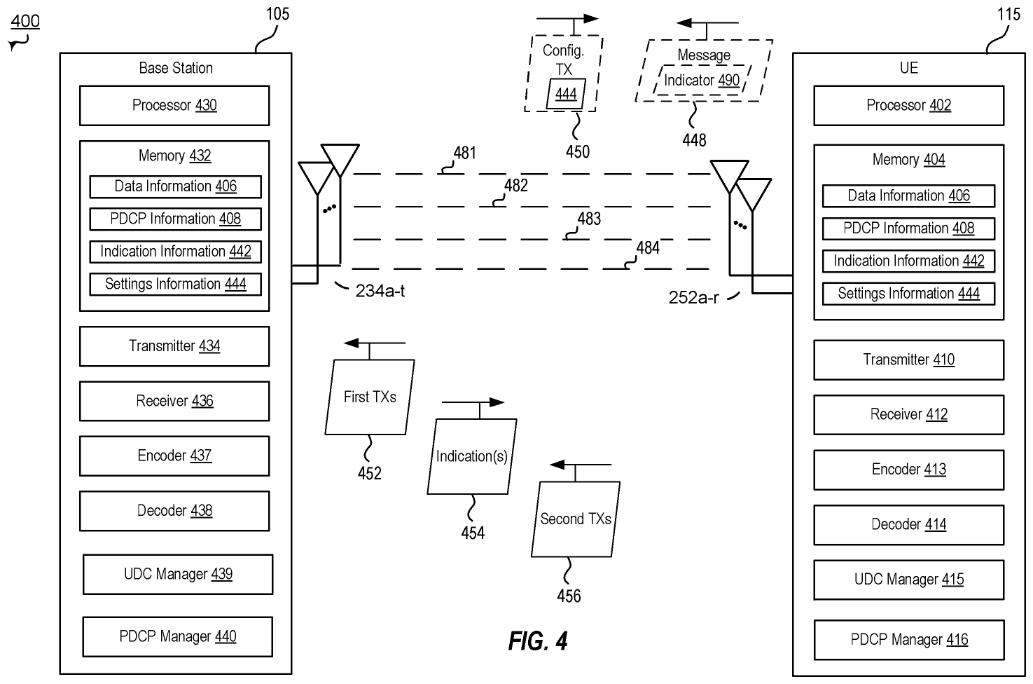

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 4-12, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Uplink data compression (UDC) may be used by wireless communication devices to compress data for increasing throughput and coverage. UDC may involve compression of data packets, such as payload data. This payload data may include or correspond to application data (e.g., music, video, text, etc.). UDC may involve using certain compression algorithms or techniques. One such technique is the DEFLATE algorithm. UDC processing may involve a compression buffer at a transmitting device and a decompression buffer at a receiving device. The compression buffer and decompression buffer may be synchronized to enable packet processing (e.g., compression/decompression) in sequence. With sequence based or sequential compression techniques, in sequence processing is utilized to ensure proper operation (e.g., error free or lossless decoding) and optionally to prevent buffer errors, such as buffer checksum errors. This is because a compressed packet has dependence on a previous compressed packet.

A UDC checksum error involves a mismatch between a checksum field in a header (UDC header) of a UDC packet and a checksum value of a decompression buffer. In operation, a packet will be compressed and a checksum value of the compression buffer of a transmitting device will be inserted into a header of a UDC packet. During receive processing by a receiving device, the checksum value of the UDC packet will be determined (e.g., parsed) and compared to a checksum value of the decompression buffer. If they are the same, the packet passes and proceeds to processing and decompression. If they are different, an error is determined and signaling may be sent. There error may be indicative of incorrect dependence and likely errors in decompression.

The checksum values of the compression and decompression buffers may be synchronized. For example, one or more values of the buffers may be the same and be adjusted based on the packets stored in the buffer. To illustrate, a checksum value of the buffers may utilize or be based on a first 4 bytes and a last 4 bytes of the respective buffers. As the buffers may utilize bits of information from a beginning and end of the buffer, the buffers may generate packets with forward and backwards compatibility or dependency for processing. That is, the devices may process a current packet based on a previous packet or a subsequent packet.

When an error is determined and signaling is sent, both buffers are reset. For example, each buffer is cleared of packets (PDCP PDUs) and the values of the buffers may be set to zero. However, clearing the packets of the buffers can cause latency and processing issues. For example, clearing the buffers may cause a delay and/or drop in packet reception and processing. To illustrate, the packets that are already submitted to the lower layer have to be discarded (a gap) when the receiving device starts to receive the new first compressed PDCP PDU. Such a gap may cause the potential packets loss in certain modes (e.g., an acknowledgement mode (AM)), and the unnecessary transmission in lower layer may result in the uplink interference which also should be prevented.

In some implementations, the packets may be associated with a timer which indicates a time when the packets to cease to be useful. To illustrate, the packets may have or be associated with a reordering timer for reordering the packets for use at the receiving device, where keeping the packets past this time the packets may cease to be useful. Also, when operating in an AM mode or other lossless mode this may not be desired or cause operational issues.

As indicated above, those cleared packets of the buffers and those packets that are already submitted to the lower layer before the reception of the UDC control PDU may not be decoded (e.g., may be useless) because there is a break in the chain of packets and subsequent decoding of packets is based on having the entire, and correct, previous sequence.

In some implementations, when the checksum error is detected, the subsequent packets delivered from the lower layer cannot be processed because of the packets dependence in the de-compression buffer, and a single previous bad packet impacts the decompression of each subsequent packet.

There a few ways to currently resolve compression buffer errors, however these solutions either incur packet losses or incur large latency and overhead costs. None of the current lossless solutions can avoid a large latency penalty and overhead increase.

Continued transmission is one way to resolve a buffer error. In such implementations, the buffers are cleared upon determination and signaling of an error. Then the transmitting device picks up where it left off, at a head of the line (HOL), and begins transmitting based on the reset buffer. All packets between the last successfully processed packet by the receiver and the last packet transmitted by the transmitter before receiving the buffer error indication and resetting its buffer are not processable or recoverable. This is not acceptable for certain application and data transmitting modes (e.g., AM or lossless).

A second way to resolve a buffer error is selective retransmission. Selective retransmission involves resending the problematic packet and the continuing along at the HOL. Similarly, selective retransmission also suffers from dropped packets when sequence based compression is used as the selective retransmission of a single packet won't help resolve the buffer mismatch of the previously sent packets. Thus, the selective retransmission cannot enable the decoding or decompression of any of the packets sent after the last successfully processed packet by the receiver and the last packet transmitted by the transmitter before receiving the buffer error indication.

A third way to resolve a buffer error is complete retransmission. Complete retransmission satisfies the requirements for certain modes (e.g., AM or lossless), but it involves a large latency penalty and large amount of overhead (retransmitting packets already received and processed). In complete retransmission, the transmitting device resets the buffer and retransmits every packet in the sequence starting from the beginning. This incurs a large delay and wastes many transmission resources and is not a workable solution in practice.

In the aspects described herein, we described methods and devices for continuous retransmission (or selective continuous retransmission). In continuous retransmission, an indication of a last processed packet is provided (or first unsuccessful packet). From this information, the transmitting device may reset the buffer and selectively retransmit each packet in the sequence that was transmitted after the error was determined (after the last processed packet).

Such continuous retransmission is currently not possible as there is no mechanism for indication of where the error occurred and because of the reporting issues between layers do not even provide feedback for some such issues.

When performing continuous retransmission, the transmitting device reverts back to a previously sent SDU for processing, such as the same SDU as selective retransmission. The transmitting device processes this SDU, and each SDU transmitted after the last processed PDCP PDU at the receiving device, for retransmission. For example, the transmitting device generates new or second PDCP PDUs based on the undecodable SDUs for retransmission. The transmission of this group of SDUs with buffers that have been reset and synchronized enables the received Device

In this continuous retransmission process, the transmitting device may have options in numbering or identifying the new or second PDCP PDUs for retransmission. For example, the transmitting device may number or identify the new or second PDCP in multiple ways, such as by restarting the numbering, continuing the numbering from the error packet, or continuing the numbering from the last sent packet.

Additionally, or alternatively, operations of the receiving device can be changed to enable continuous retransmission and resolution of UDC buffer errors. For example, a receiving device may perform additional actions after determination of a buffer error or after transmission of the UDC control PDU. For example, the receiving device may refrain from reporting or acknowledging RLC SDUs which are not delivered to the PDCP layer.

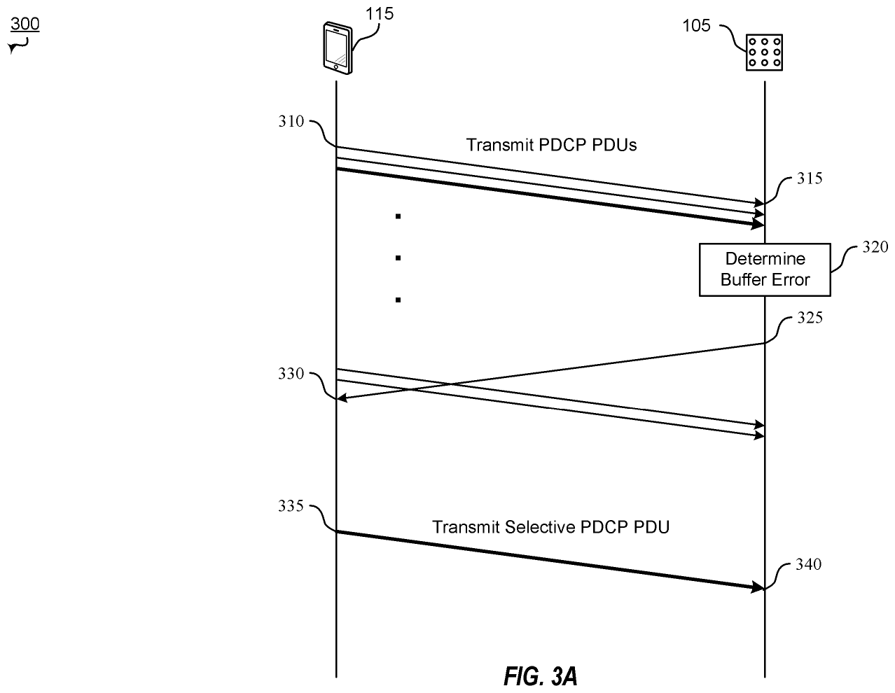

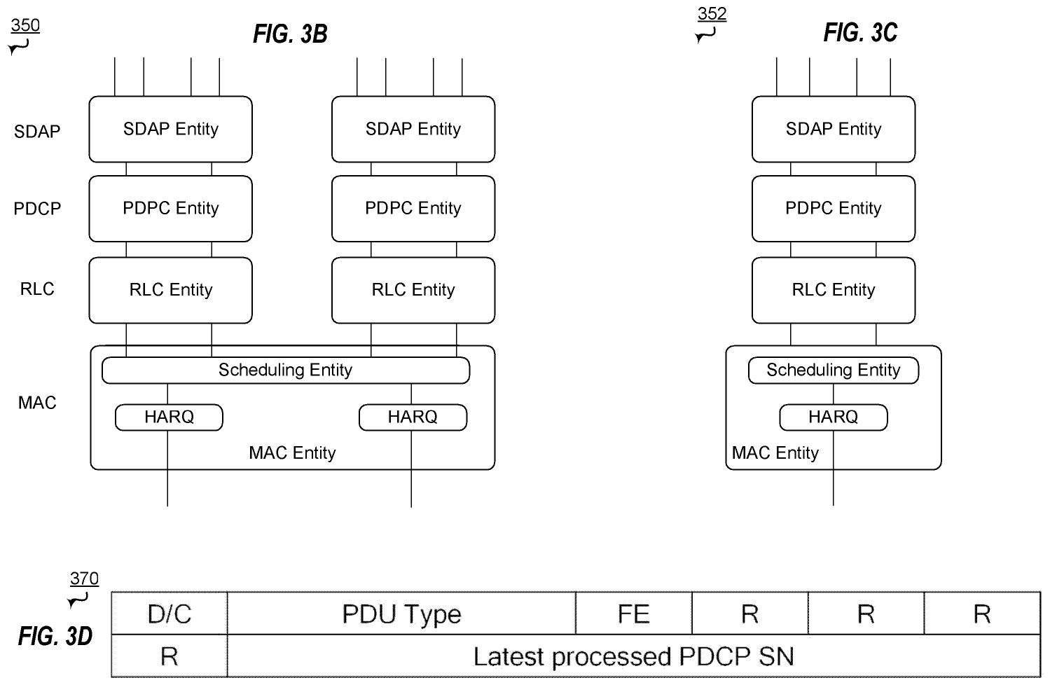

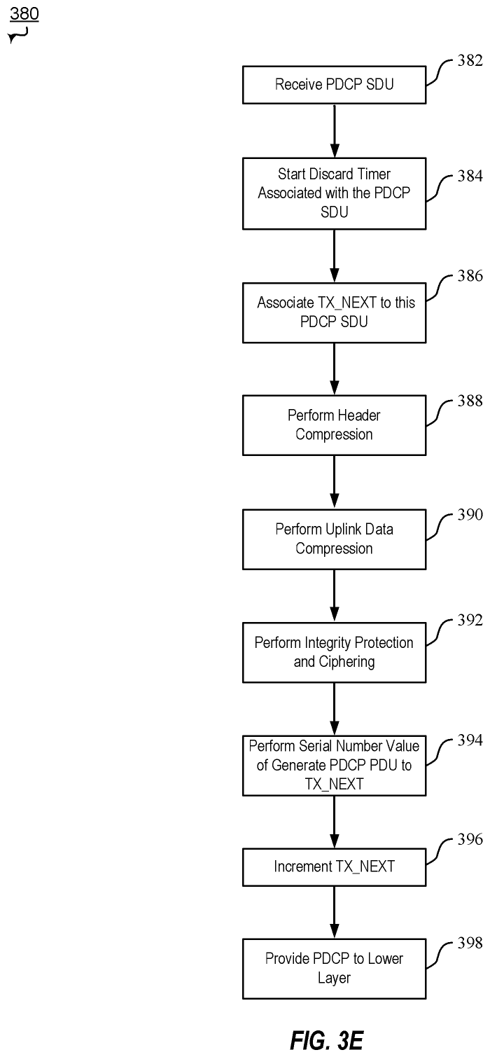

Referring to FIG. 3A, a timing diagram 300 illustrating an example of buffer error resolution according to one or more aspects is depicted. In FIG. 3A, transmissions are illustrated as diagonal lines and occurring in time with a transmission start time and a transmission receive time. This is to illustrate intervening actions by the other, non-transmitting device.

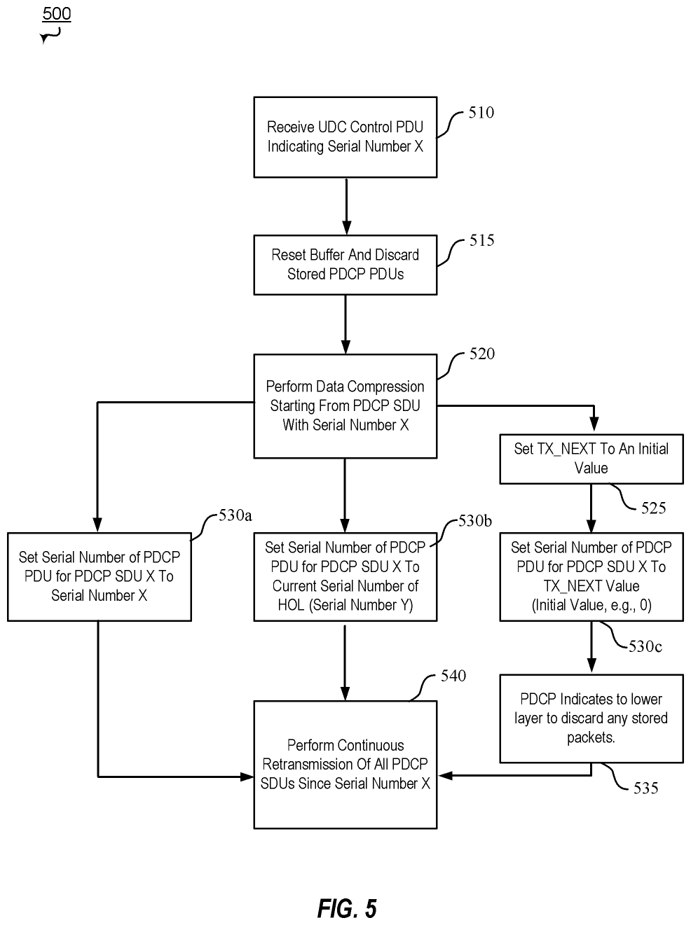

At 310, a UE 115 starts transmitting PDCP PDUs. For example, the UE 115 processes (e.g., compresses) SDUs to generate corresponding PDUs, and the UE 115 transmits the PDUs to the base station 105. The PDCP PDUs may be included or encapsulated in lower layer data units before transmitting. The SDUs may include application data and correspond to a sequence of SDUs including data, such as music data, video data, etc. Processing the SDUs may include compressing payload date thereof, such as performing uplink data compression (UDC). Description and examples of processing SDUs to generate PDUs are described further with reference to FIGS. 3B, 3E, and 5.

At 315, a base station 105 starts receiving the PDCP PDUs. For example, the base station 105 receives PDCP PDUs and begins to process the PDCP PDUs in the order received and/or the order indicated by the PDUs. Processing the PDUs may include decompressing the PDUs. Description and examples of processing SDUs to generate PDUs are described further with reference to FIGS. 3C, 3E, and 5.

As indicated, the base station 105 receives the transmitted PDCP PDUs from the UE 115, and optionally begins processing them, while the UE 115 is still transmitting additional PDCP PDUs of the sequence.

At 320, the base station 105 determines a buffer error. For example, the base station 105 while decoding a particular PDCP PDU determines a buffer checksum error. As illustrated in the example of FIG. 3A, the base station determines an error with PDCP PDU with serial number 100 (SN 100) (e.g., packet 101) based on a checksum value of PDCP PDU SN 100 not matching a checksum value determined based on the PDCP UDC decompression buffer of the base station 105.

At 325, the base station 105 sends an indication of the buffer error to the UE 115. As indicated in the example of FIG. 5, at this time 325, the UE 115 is still transmitting PDCP PDUs of the sequence. For example, the UE 115 is transmitting PDCP PDU SN 101 through PDCP PDU SN 120.

At 330, the UE 115 receives the buffer error indication and stops transmitting PDCP PDUs. For example, the UE 115 receives the buffer error indication after transmitting PDCP PDU SN 120, but before transmitting PDCP PDU SN 121 and determines to reset the buffer to resynchronize the compression buffer with the decompression buffer of the base station 105.

At 335, after the buffer reset, the UE 115 either starts up again with a next PDCP PDU (PDCP PDU SN 121) or has to start all over from the first PDCP (PDCP PDU 0) depending on the operation mode. Specifically, in the example of FIG. 3A, the base station cannot decode PDCP PDU SN 100 (with the error) and any PDU thereafter (SN 101-SN 120) due to the decompression being buffer based or sequence based.

As an example of dropping packets, at 340, the base station 105 determines a t-reordering timer expires and attempts to deliver the received and stored PDCP PDUs in ascending order. However, PDCP PDU 100 and any PDCP PDU thereafter are dropped because they cannot be decoded. Sending a new PDCP PDU with a reset compression buffer will not solve the issue of buffer mismatch or help the base station to decode PDCP PDU SNs 100-120.

FIGS. 3B and 3C depict block diagrams of a downlink stack and an uplink stack respectively. Referring to FIGS. 3B and 3C, FIG. 3B depicts a user plane stack for downlink (e.g., a UE 115 transmitting), and FIG. 3C depicts a user plane stack for uplink (e.g., a base station 105 receiving).

The stacks (e.g., user plane protocol stack) include a Service Data Adaptation Protocol (SDAP) layer, a Packet Data Convergence Protocol (PDCP) layer, a Radio Link Control (RLC) layer, a Medium Access Control (MAC) layer, and a Physical (PHY) layer. The SDAP layer is configured to provide a mapping between QoS flow and a data radio bearer, marking QoS Flow ID (QFI) in both uplink and downlink. A single SDAP (e.g., single SDAP entity) may be configured for each Protocol Data Unit (PDU) session in some schemes. In Dual Connectivity (DC), two SDAP entities may be configured, such as two user plane stacks illustrated in FIG. 3B.

The PDCP layer is configured to perform services and functions that include sequence numbering, transfer of user data, reordering and duplicate detection, PDCP PDU routing (e.g., for split bearers), retransmission of PDCP SDUs, and duplication of PDCP PDUs. The RLC layer is configured to perform services and functions that include the transfer of upper layer PDUs, sequence numbering, segmentation and re-segmentation.

The MAC layer is configured to perform services and functions that include mapping between logical channels (LCHs) and transport channels, multiplexing and demultiplexing of MAC SDUs, and logical channel prioritization. A single logical channel may be mapped to one or more numerologies and/or TTI durations. For example, in LCP, the MAC layer (e.g., one MAC entity of the layer) determines a TTI duration or numerology from the physical layer.

The MAC layer provides services to the RLC layer in the form of logical channels. A logical channel is defined by the type of data/information it carries and is generally referred to as a control channel and used from transmission of control and/or configuration or as a traffic channel used for user data. The PHY layer is configured to perform services and functions that include mapping between transport channels and physical channels.

As illustrated in the block diagram 350 of FIG. 3B, the downlink or UE side user plane stack includes two SDAP entities. Each SDAP entity includes two PDCP entities, two RLC entities, and a MAC entity. The MAC entity includes a scheduler and a HARQ entity.

During operation, the SDAP entity generates a PDCP SDU and transmits the PDCP SDU to a PDCP entity. The PDCP entity generates a PDCP header and combines the PDCP header and the PDCP SDU to generate a first PDCP PDU. The PDCP entity transmits the PDCP PDU to the corresponding RLC entity. The RLC entity may perform RLC operations on the PDCP PDU, such as add a corresponding RLC header. The RLC entity transports the PDCP PDU (e.g., RLC modified PDCP PDU) to the MAC entity.

The scheduler may determine the specific uplink grant to use (e.g.,. perform logical channel mapping) for the PDCP PDU and which HARQ entity to send the PDCP PDU. The PDCP PDU is then deliver to transport channels for over the air transmission, such as to the uplink structure of FIG. 3C.

As illustrated in in the block diagram 352 of FIG. 3C, the uplink or network side user plane stack includes a single SDAP entity. The SDAP entity includes two PDCP entities, two RLC entities, and a MAC entity. The corresponding entities of the uplink stack may perform similar actions to those of their downlink counterparts in FIG. 3B. For example, an RLC entity may provide RLC SDUs/PDCP PDUs to the PDCP entity for processing (e.g., decompressing) to generate PDCP SDUs.

Referring to FIG. 3D, a block diagram illustrating an example of a control PDU is depicted. In FIG. 3D, an example of a field layout field layout of a PDU control message 370 is illustrated. The PDU control message 370 may include or correspond to a downlink transmission. The PDU control message 370 includes one or more fields. As illustrated in FIG. 3C, the PDU control message 370 includes a D/C field, a PDU type field, an FE field, and a latest processed PDCP SN field. The PDU control message 398 also includes reserve or reserved bits (R). The reserve or reserved bits (R) may be in other places in other examples or may be used for to indicate other information.

The D/C field indicates whether the PDU is a control or data PDU, such a 0 for control and 1 for data. The FE field (or bit) may be configured to indicated whether a checksum error was detected or not. The PDU type field may indicate a type of the PDU control message, such as a UDC PDCP PDU control message, or a type of the PDU data message. For example, a value of 011 may indicate UDC feedback in NR. The PDU type field may further indicate a layout and/or length of the PDU control (or data) message. Although four fields are illustrated in FIG. 3C, the PDU control message may include more than four fields or fewer than four fields.

Referring to FIG. 3E, a block diagram 380 illustrating an example processing flow for a PDCP layer is depicted. Processing a PDCP packet (e.g., PDCP SDU) may be performed by a PDCP layer and may include multiple steps. One such example is illustrated in FIG. 3E.

As an illustrative example of processing a PDCP packet (e.g., a PDCP SDU), a device (or PDCP layer thereof) receives, at 382, a PDCP SDU from a higher layer, such as SDAP layer or entity. The PDCP SDU may be stored in a PDCP buffer, such as a PDCP SDU buffer.

The device, at 384, may start a discard timer associated with this PDCP SDU (or a group of PDCP SDUs which include the PDCP SDU) based on receiving the PDCP SDU, such as when the PDCP is place in or received at the PDCP SDU buffer.

The device, at 386, may associate this PDCP SDU with a sequence number or variable to indicate its position or order. For example, the device may associate the PDCP SDU with TX_NEXT.

The device, at 388, may perform header compression. For example, the device may compress the header using Robust Header Compression (ROHC). The device, at 390, may perform UDC. For example, the device may process the data using a lossless compression algorithm, such as the DEFLATE algorithm.

The device, at 392, may perform integrity protection and ciphering. For example, the device may process the data or set restrictions on who can access or modify the data. This processing may include applying algorithms to protect the data.

The compression of the header, the data (UDC), and the protection processing may generate a PDCP PDU from and/or which includes the PDCP SDU. The device, at 394, may set a serial number value of the PDCP PDU to a value of TX_NEXT. The PDCP PDU and the PDCP SDU may have the same serial number as both were associated with or set to the TX_NEXT.

The device, at 396, may then increment a sequence number or state variable for a next SDU or PDU. For example, the device may increment a TX_NEXT value by one. The device, at 398, may provide the processed (and compressed) PDCP PDU to a lower layer. For example, the device provides the PDCP PDU with compressed payload data to a RLC layer for routing.

FIG. 4 illustrates an example of a wireless communications system 400 that supports enhanced buffer error resolution operations in accordance with aspects of the present disclosure. In some examples, wireless communications system 400 may implement aspects of wireless communication system 100. For example, wireless communications system 400 may include a network, such as one or more network entities, and one or more UEs, such as UE 115. As illustrated in the example of FIG. 4, the network entity includes or corresponds to a base station, such as base station 105. Alternatively, the network entity may include or correspond to a different network device (e.g., not a base station). Enhanced buffer error resolution operations may reduce latency and increase throughput, while also being lossless. For example, performing continuous retransmission may enable retransmission of affected packets for UDC or other sequence based compression/decompression. Accordingly, network and device performance can be increased.

Base station 105 and UE 115 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management or BWP switching functionality. In some implementations, two or more CCs are quasi co-located, such that the CCs have the same beam and/or same symbol.

In some implementations, control information may be communicated via base station 105 and UE 115. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, UDC manager 415, PDCP manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store data information 406, PDCP information 408, indication information 442, settings data 444, or a combination thereof, as further described herein.

The data information 406 includes or corresponds to uplink data associated with or corresponding to application data, such as payload data. For example, the data information 406 may include or correspond to PDCP payload data which is compressed for UDC. In some implementations, the data information 406 further includes or corresponds to PDCP PDUs or SDUs, such as PDUs or SDUs stored in a PDCP buffer.

The PDCP information 408 includes or corresponds to data associated with or corresponding to PDCP layer data and/or operations. For example, the PDCP information 408 may include serial number information, TX_NEXT information, COUNT information, buffer checksum information, or a combination thereof. The PDCP information 408 may include information for determining a checksum value, determining to reset a buffer, or a combination thereof.

The indication information 442 includes or corresponds to indication data for PDCP and/or UDC operations. For example, the indication information 442 may include or correspond to buffer error indication data, serial number data associated with a buffer error, or a combination thereof.

The settings data 444 includes or corresponds to data associated with enhanced buffer error resolution operations. The settings data 444 may include one or more types of enhanced buffer error resolution operation modes and/or thresholds or conditions for switching between enhanced buffer error resolution modes and/or configurations thereof. For example, the settings data 444 may have data indicating different thresholds and/or conditions for different enhanced buffer error resolution modes, such as a continuous retransmission mode, serial number revert mode, serial number continuation mode, serial number reset mode, etc., or a combination thereof.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. UDC manager 415 may be configured to perform resource allocation determination operations. For example, UDC manager 415 may be configured to determine and/or perform UDC operations. To illustrate, the UDC manager 415 may be configured when and how to perform uplink data compression. The UDC manager 415 may be configured to perform compression and/or decompression. As an illustrative example, the UDC manager 415 may be configured to perform a DEFLATE algorithm to compress payload/application data. Additionally, the UDC manager 415 may be configured to determine packet checksum values, determine buffer checksum values, compare checksum values, assign serial numbers, or a combination thereof.

PDCP manager 416 may be configured to perform improved PDCP operations, such as continuous retransmission operations. For example, PDCP manager 416 may be configured to determine when and how to perform continuous retransmission operations. To illustrate, the PDCP manager 416 may receive an indication of a buffer error and may determine to reset a PDCP buffer.

Additionally, the PDCP manager 416 may be configured to perform PDCP layer operations, such as PDCP processing. Examples of PDCP layer operations for processing packets are shown and described further with reference to FIGS. 3B, 3C, and 3E. In addition, the PDCP manager 416 may be configured to determine a serial number for retransmitted packets. Examples of PDCP layer operations for determining a serial number are shown and described further with reference to FIG. 5.

Base station 105 includes processor 430, memory 432, transmitter 434, receiver 436, encoder 437, decoder 438, UDC manager 439, PDCP manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store data information 406, PDCP information 408, indication information 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver, 436 may include or correspond to one or more components of UE 115 described with reference to FIG. 2.

Encoder 437, and decoder 438 may include the same functionality as described with reference to encoder 413 and decoder 414, respectively. UDC manager 439 may include similar functionality as described with reference to UDC manager 415. For example, the UDC manager 439 may be configured perform UDC processing operations with decompression. PDCP manager 440 may include similar functionality as described with reference to PDCP manager 416.

During operation of wireless communications system 400, the network (e.g., base station 105) may determine that UE 115 has enhanced buffer error resolution capability. For example, UE 115 may transmit a message 448 that includes an enhanced buffer error resolution indicator 490 (e.g., an enhanced buffer error resolution capability indicator). Indicator 490 may indicate enhanced buffer error resolution capability for one or more communication modes, such as downlink, uplink, etc. In some implementations, a network entity (e.g., a base station 105) sends control information to indicate to UE 115 that enhanced buffer error resolution operation and/or a particular type of enhanced buffer error resolution operation is to be used. For example, in some implementations, configuration transmission 450 is transmitted to the UE 115. The configuration transmission 450 may include or indicate to use enhanced buffer error resolution operations or to adjust or implement a setting of a particular type of enhanced buffer error resolution operation. For example, the configuration transmission 450 may include settings data 444, as indicated in the example of FIG. 4, data information 406, PDCP information 408, indication information 442, or any combination thereof.

During operation, devices of wireless communications system 400, perform enhanced buffer error resolution operations. For example, the network and UE 115 may exchange transmissions via uplink and/or downlink communications with UDC. The network (e.g., base station 105) and the UE 115 may perform continuous retransmission to recover from UDC buffer errors, as illustrated in the example of FIG. 4. Continuous retransmission may enable devices to provide lossless recovery from buffer errors without incurring large latency and overhead costs.

In the example of FIG. 4, the UE 115 transmits a plurality of first transmissions 452 to the base station 105 via an uplink channel. The plurality of first transmissions 452 may include or correspond to a first plurality of PDCP PDUs. For example, the UE 115 transmits a plurality of transmissions where each transmission includes one or more PDCP PDUs. Each PDU may have its own corresponding SDU. The UE 115 may generate PDUs from SDUs, as described with reference to FIGS. 3B, 3E, and 5. The PDCP PDUs may be compressed PDUs, such as PDCP UDC PDUs. The plurality of first transmissions 452 may include or correspond to a portion of transmissions of an entire sequence of transmissions, such as 101 transmissions of a 400 transmission sequence.

The base station 105 receives the plurality of first transmissions 452 and attempts to process, such as decode and/or decompress, the plurality of first transmissions 452. For example, the base station 105 receives each PDCP PDU of the plurality of PDCP PDUs of or corresponding to the plurality of first transmissions 452. The base station 105 may process the PDUs to generate SDUs. To illustrate, the base station 105 may use a decompression buffer to decompress the PDUs.

From time to time, the base station 105 may experience a processing error when processing the received plurality of first transmissions 452. For example, the base station 105 may determine a UDC buffer checksum error. To illustrate, the base station 105 may parse a received PDCP packet (PDCP PDU) and determine a value of a checksum field. The base station 105 may also determine a checksum value of the UDC decompression buffer, such as based on a first four and last four bits or bytes of the buffer. The base station 105 may compare the two determined checksum values to determine if there was an error. If the values are the same or match, the base station 105 proceeds to decoder the PDCP packet. If the values are not the same or do not match, the base station 105 determines the UDC buffer checksum error.

Based on determining the UDC buffer checksum error, the base station 105 transmits an indication 454 to the UE 115 via a downlink channel. For example, the base station 105 may transmit the indication 454 in a UDC control PDU. The indication 454 (or UDC control PDU) may indicate a buffer checksum error and a particular serial number associated with the error. The serial number of the indication 454 may include or correspond to a serial number of the last successfully processed PDU or a serial number of first failed PDU. The indication 454 may include or correspond to a buffer error indication, a PDU error identification, or a combination thereof. The indication 454 may be configured to reset or synchronize (resynchronize) the buffers of the base station 105 and the UE 115.

The UE 115 receives the indication 454. After receiving the indication 454, the UE 115 determines to perform continuous retransmission based on the indication 454. For example, the UE 115 may reset a buffer and prepare to retransmit a portion of the plurality of first transmission 452 as second transmissions 456. The portion of the plurality of first transmissions 452 to be retransmitted may be determined based on a serial number of the indication 454 and corresponds to the serial numbers and PDUs/SDUs for which were transmitted by the UE 115 but not processed by the base station 105. Due to timing and processing delays, the UE 115 may transmit multiple transmission of the plurality of first transmissions 452 after the particular transmission in which the base station received the error. For example, if the base station 105 determined an error for serial number 100, it may have received or the UE 115 may have sent an additional 20 transmissions (with a last transmission being serial number 120).

To illustrate, the UE 115 may discard all processed PDUs stored in the buffer in resetting the buffer. For example, the UE 115 set the buffer values to all zeros. The UE 115 may proceed to then process SDUs to generate PDUs based on the serial number of the indication 454. The processing of the SDUs to generate PDUs may include one or more operations as described with reference to FIGS. 3B, 3E, and 5. The UE 115 may then label the generated PDUs based the serial number of the SDU (e.g., the serial number received), a current or next serial number (e.g., a HOL value), or an initial serial number (e.g., 0).

After generation of one or more of the PDUs, the UE 115 transmits the PDUs as the second transmissions 456 based on the indication 454. For example, the UE 115 transmits the generated PDUs as retransmissions, where the generated PDUs include or correspond to SDUs which have a serial number equal or greater the serial number of the indication 454. To illustrate, the UE 115 may retransmit compressed PDUs for failed SDUs of the plurality of first transmissions 452. In some implementations, the initial or first transmission of the second transmissions indicates that the compression buffer of the UE 115 was reset. For example, an FR field of a compressed PDU may indicate if a buffer was reset. To illustrate, the FR field of a first compressed PDU may be set to a value of 1 to indicate a buffer was reset.

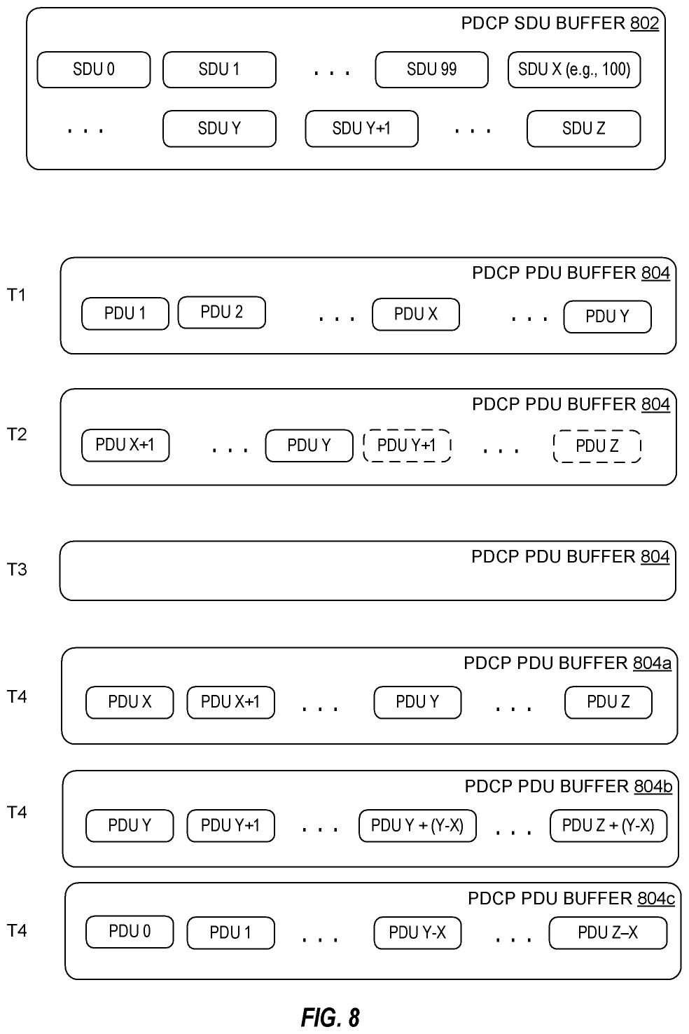

In some implementations, the UE 115 may transmit or receive additional transmissions (e.g., third transmission) of the sequence to complete the transmission of the sequence, based on the scheduling information, as described further with reference to FIG. 8. In other implementations, the UE 115 may transmit or receive second transmissions (e.g., aperiodic) of the transmissions 456 based on second scheduling information received in additional transmissions, such as a second signaling transmission, as described further with reference to FIG. 5.

Transmission of a PDCP PDU as described herein may include: to provide the PDCP PDU to a second layer for processing before transmission of the PDCP PDU over the air; or the transmission of the PDCP PDU over the air.

In some of the ways, the transmitting device may set the serial number (or another identifying value) based on the indication from the receiving device, such as based on the serial number of the last processed PDU. In some other of the ways, the transmitting device may set the serial number (or another identifying value) based on TX_NEXT or another state variable. TX_NEXT is a state variable that holds the value of the serial number to be assigned for the next newly generated PDU. In some additional ways, the transmitting device may first set the TX_NEXT (or another state variable) to a particular value, and then set the serial number based on the new TX_NEXT value.

In a first option, the transmitting device performs retransmission of new or second PDCP SDUs starting from a serial number (e.g., serial number X) indicated from the UDC control PDU. Serial number X may be associated with a count (e.g., COUNT) value. To illustrate, the COUNT value may include the serial number as a field or portion thereof. The transmitting device may perform retransmission of the new or second PDCP SDUs in the ascending order of the COUNT values until all previously transmitted PDCP SDUs have been retransmitted, and then the transmitting device may continue to transmit the rest of the untransmuted SDUs of the sequence.

In transmitting the PDUs, the transmitting device performs uplink data compression of each PDCP SDU indicated above. Additionally, the transmitting device retransmits all the PDCP SDUs since the serial number indicated by the UDC control PDU (SN X) no matter whether the PDCP data PDU is confirmed by a lower layer or not. Such operations require no signaling, changes or specialized handling by the receiving device. The receiving device expects to receive a newly compressed PDCP SDU X with the FR field indicating a buffer reset. When PDCP SDU X is compressed after the compression buffer is reset, the payload of the new or second PDCP PDU with serial number X is different from the first or previous PDCP PDU with serial number X because of the different compression buffer status and/or checksum value. Thus, the same packet (PDCP SDU) may be generated twice with the different payload of PDCP PDU, but that particular packet is still associated with same serial number (and optionally the same COUNT value).

In a second option, the transmitting device still performs continuous retransmission of PDCP SDUs starting from the serial number (e.g., SN X) indicated in the UDC control PDU. However, the serial number for the retransmitted PDCP PDUs may not be the same as the original transmission of the corresponding PDCP PDU (e.g., the corresponding PDCP SDU). As compared to the first option, one serial number may not be associated with a particular PDCP PDU (payload). That is, PDCP SDU X is compressed to generate to PDCP PDU X, PDCP SDU X+1 is compressed to generate to PDCP PDU X+1, and so on.

In the second option, PDCP SDU X is compressed to generate to PDCP PDU with a new or different serial number Y, PDCP PDU Y. The new or different serial number Y may be a unique number such that each PDCP PDU transmitted (including the PDUs corresponding to retransmitted SDUs) by the transmitting device does not have the same serial number.

In some such implementations, the serial number Y may correspond a next serial number to be used, such as a HOL value. For example, the serial number Y may be the latest serial number (TX_NEXT) of the HOL in a PDCP transmission queue.

In the second option, different payloads of PDCP PDU will have different serial numbers and the payload of PDU may correspond to the actual compressed UDC. If compression buffer is reset, the PDCP PDU is different even through it is or correspond to the same PDCP SDU. Thus, the receiving device (e.g., the PDCP layer thereof) can still get the original PDCP SDU and in-order delivery is preserved.

In a third option, the transmitting device still performs continuous retransmission of PDCP SDUs starting from the serial number (e.g., SN X) indicated in the UDC control PDU. In this option, the transmitting device also resets or initializes the TX_NEXT value (or another state variable) to an initial value (e.g., 0). The transmitting device then may proceed to setting the serial number of the first retransmitted PDCP PDU to the TX_NEXT value, that is the initial value for TX_NEXT. As compared to the previous options, this third option generates a “new start” when the UE receives the UDC control PDU, with the new start referring to a buffer reset and an initialization of a TX_NEXT value (or another state variable).

In some such implementations, the receiving device (e.g., base station 105) may deliver the PDCP SDUs to an upper layer in ascending order of the COUNT value. After a buffer reset, the receiving device may discard each received PDCP PDU until it receives a PDCP PDU with an indication of a buffer reset (e.g., a 1-bit indication or flag, such as an FR field set to 1) for the transmitting device. After receiving the PDCP PDU with the buffer reset indication (an initial, new or second PDCP PDU), the receiving device may begin to process the retransmitted PDCP PDUs (new or second PDCP PDUs). In a particular implementation, the receiving device may stop a timer based on determining the buffer error and/or transmitting the UDC control PDU. For example, the receiving device stops a t-reordering timer upon transmission of the PDU. The receiving device may start or restart the t-reordering timer based on receiving a PDCP PDU from the transmitting device indicating a buffer rest (FR field set to 1).

In some implementations, a receiving device may perform additional actions after determination of a buffer error or after transmission of the UDC control PDU. For example, the receiving device may send an indication to a RLC layer to stop delivering received RLC SDUs to the PDCP layer based on or responsive to the UDC control PDU being generated.

Based on receiving this indication, the receiving device (e.g., the RLC layer thereof) may not report or acknowledge the RLC SDUs which are not delivered to upper layer. For example, the RLC layer may not report an ACK_SN in an RLC Status PDU for RLC SDUs not delivered to the PDCP layer. To illustrate, a RLC status PDU may not be sent or a sent RLC status PDU will not include negative acknowledgment information for the undelivered RLC SDUs.

Accordingly, the network (e.g., the base station 105 and the UE 115) may be able to more efficiently and effectively recover from buffer errors for UDC. Improved buffer error resolution operations through continuous retransmission may increase throughput and reduce latency, which may lead to reduced link failures. Accordingly, the network performance and experience may be increased due to the increases in speed and reductions in failure.

FIG. 5 illustrates a flow diagram for resynchronizing compression and decompression buffers. In FIG. 5, three distinct processing flows are illustrated.

At 510, a transmitting device (e.g., UE 115) receives a UDC control PDU from a receiving device and determines to reset a compression buffer (TX compression buffer). For example, the transmitting device parses the UDC control PDU to determine a buffer error indication (e.g., FE field). Additionally, or alternatively, the transmitting device may determine a serial number of a last processed PDU or first unsuccessful PDU based on the UDC control PDU.

At 515, the transmitting device resets the compression buffer and discards all stored PDCP PDUs. For example, the transmitting device discards all PDCP PDUs stored it PDCP layer buffers, such as a PDCP UDC compression buffer, based on receiving the buffer error indication. The transmitting device may set all buffer values to zero to clear the compression buffer and reset it. In some implementations, the PDCP UDC compression buffer includes or corresponds to a FIFO buffer. In some such implementations, PDCP PDUs are not immediately removed from the buffer upon being transmitted or provided to lower layers. Rather, the PDCP PDUs may time out and be removed from the buffer after timing out or upon instruction.

Additionally, or alternatively, the transmitting device may not reset a PDCP SDU buffer for the PDCP layer and discard PDCP SDUs based on the buffer error indication. The PDCP SDU buffer may store all the SDUs of an entire sequence or set of data until transmissions (e.g., successful transmission or confirmation thereof) or until a timer condition.

At 520, the transmitting device identifies a starting point to resume transmission (and optionally compression) from, such as from a serial number indicated by or determined from the UDC control PDU. For example, the transmitting device may receive an indication of serial number 100 and may select serial number 100 (or 101). To illustrate, if the indication is for a last processed serial number, the transmitting device may select serial number 101, and if the indication is for a first serial number which cannot be processed, the transmitting device may select serial number 100.

In the first processing flow, after 520, the transmitting device proceeds to 530a for PDU processing and a first type of serial number assigning. At 530a, the transmitting device processes (e.g., compresses) the PDCP SDU to generate a PDCP PDU and sets the serial number of the PDCP PDU to the serial number of the PDCP SDU. For example, the transmitting device may set the serial number of PDCP PDU to the serial number received in UDC control PDU or to the serial number of the PDCP SDU (which was identified based on the serial number received in UDC control PDU). Alternatively, the transmitting device may set the serial number of PDCP PDU based on the serial number received in UDC control PDU, such as to one value higher when the UDC control PDU indicates a last successful PDCP PDU. As another example, the transmitting device may set a count or TX_NEXT value based on the indication in the UDC control PDU and may use the count or TX_NEXT value to identify the PDCP SDU and to set the serial number value of PDCP PDU.

After 530a, the transmitting device may proceed to 540 and perform continuation transmission to complete the first processing flow. Alternatively, the transmitting device may perform alternative options for setting the serial number of PDCP PDUs. For example, the transmitting device may perform the operations described with reference to the second or third processing flows to perform other options for setting the serial number of PDCP PDUs.

In a second processing flow, after 520, the transmitting device proceeds to 530b for PDU processing and a second type of serial number assigning. At 530b, the transmitting device processes (e.g., compresses) the PDCP SDU to generate a PDCP PDU and sets the serial number of the PDCP PDU to a current serial number of a HOL. For example, the transmitting device may set the serial number value of PDCP PDU to a HOL value, such as based on the value of a last transmitted PDCP PDU. To illustrate, the transmitting device may set the serial number value of PDCP PDU to a next or subsequent value (e.g., 121) to the serial number value of the last transmitted PDCP PDU (e.g., 120). Alternatively, the transmitting device could chose a value subsequent to (e.g., 101) a serial number value of a last processed PDCP PDU (e.g., 100).

In a third processing flow, after 520, the transmitting device proceeds to 525c for PDU processing and a third type of serial number assigning. At 525c, the transmitting device may initialize the variable TX_NEXT. For example, the transmitting device may set the serial number value of PDCP PDU to an initial or initialized value, such as 0 or 1. To illustrate, the transmitting device could set the count value or the TX_NEXT value to the initialized value (e.g., reset the value) and then, at 530c, the transmitting device processes (e.g., compresses) the PDCP SDU to generate a PDCP PDU and sets the PDCP PDU value based on the initialized count value or TX_NEXT value. Alternatively, the transmitting device may set the serial number value of PDCP PDU to an initial value (0) directly first and then reset TX_NEXT or not reset (e.g., ignore) TX_NEXT at all.

At 535, after 530c the transmitting device instructs a lower layer to discord any stored packets. For example, the transmitting device generates and provides one or more indications to lower layers, such as a RLC layer, indicating to discard all packets corresponding to this PDCP instance or data of this application.

At 540, after processing the PDCP SDU to generate the PDCP PDU, the transmitting device may transmit the processed PDCP PDU and perform continuous retransmission of all PDCP SDU transmitted after the last processed PDCP PDU/SDU. For example, the transmitting device may transmit the PDCP PDU to a lower layer for further processing and wireless transmission.

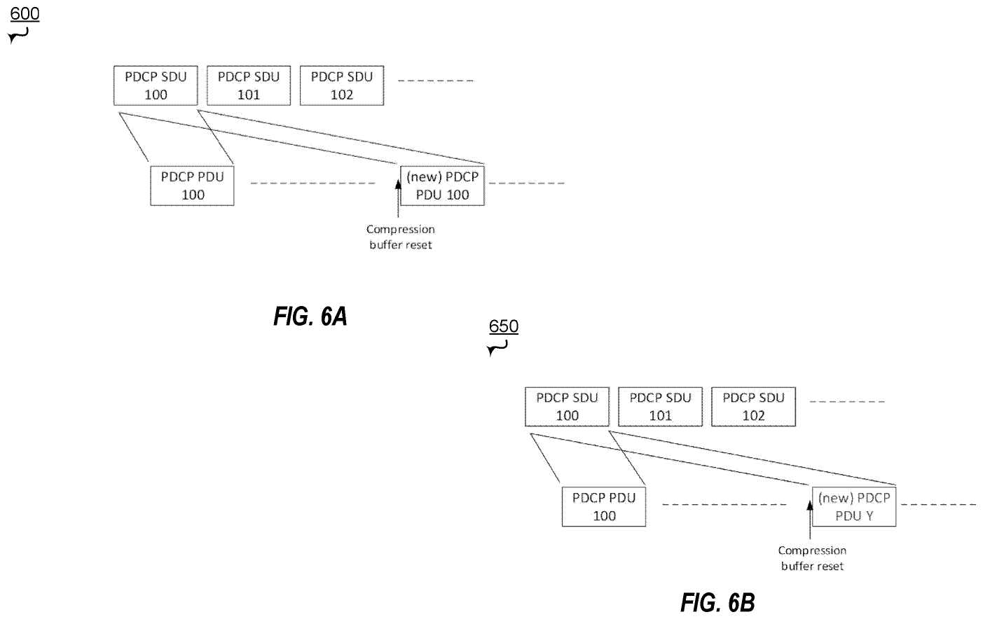

FIGS. 6A and 6B illustrate PDCP layer operations at a transmitting or downlink device. For example, FIGS. 6A and 6B PDCP layer operations corresponding to FIG. 5. To illustrate, a top row represents data to be sent and a bottom row illustrates PDCP PDU transmissions. The top row may represent data receive at the PDCP layer from the SDAP layer and correspond to SDUs stored in a SDU buffer or queue. SDUs are converted into PDUs and transmitted to a receiving device as shown by the arrows from the SDUs to the bottom line. With respect to FIG. 5, the UE 115 transmits PDCP PDUs 0-120 based on corresponding PDCP SDUs 0-120. FIG. 6A depicts the period of time when PDCP PDU 100 (including or corresponding to PDCP SDU 100) is sent and an error is detected until the buffer is reset and a new PDCP carrying PDCP SDU 100 is retransmitted. In the Example of FIG. 6A, the new PDCP PDU carrying PDCP SDU 100 is labeled 100, that is has a serial number with a value of 100. In FIG. 6A, the serial number used for the first retransmission corresponding to the last processed or successfully received and decoded/decompressed PDCP PDU and PDCP SDU.

FIG. 6B illustrates a similar example where a different value or serial number is chosen for the first retransmission (corresponding to the last processed or successfully received and decoded/decompressed PDCP PDU and PDCP SDU) is denoted by the value Y. The value Y may indicate an initial or initialized value such as 0 or 1 or may indicate another value, such as HOL value. The head of line value may indicate a next in line value, such as a value that is subsequent to the last serial number transmitted. In this example, where the last PDCP PDU (and corresponding PDCP SDU) transmitted had a serial number of 120. Thus, the value Y for the serial number of the PDCP PDU may be 121. As indicated in FIG. 6B, the PDCP PDU with the serial value of 121 still include or corresponds to the PDCP SDU with a serial number value of 100 (PDCP 100) and the last processed PDCP SDU.

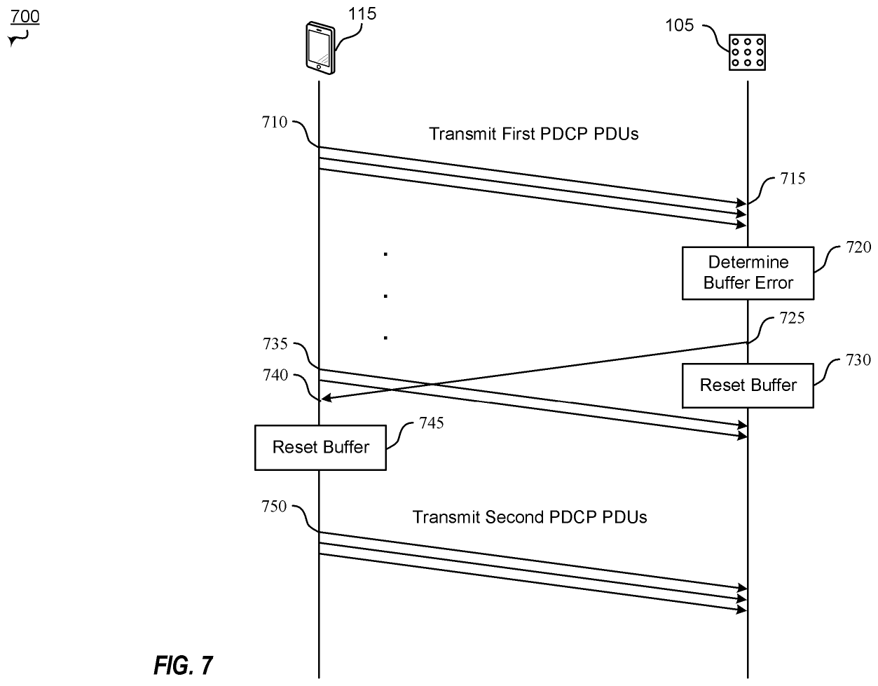

Referring to FIG. 7, a timing diagram 700 illustrating an example of buffer error resolution according to one or more aspects is depicted. In FIG. 7, transmissions are illustrated as diagonal lines and occurring in time with a transmission start time and a transmission receive time. This is to illustrate intervening actions by the other, non-transmitting device.

At 710, a UE 115 starts transmitting PDCP PDUs. For example, the UE 115 processes (e.g., compresses) SDUs to generate corresponding PDUs, and the UE 115 transmits the PDUs to the base station 105. The PDCP PDUs may be included or encapsulated in lower layer data units before transmitting. The SDUs may include application data and correspond to a sequence of SDUs including data, such as music data, video data, etc. Processing the SDUs may include compressing payload date thereof, such as performing uplink data compression (UDC). Description and examples of processing SDUs to generate PDUs are described further with reference to FIGS. 3B, 3E, and 5.

At 715, a base station 105 starts receiving the PDCP PDUs. For example, the base station 105 receives PDCP PDUs and begins to process the PDCP PDUs in the order received and/or the order indicated by the PDUs. Processing the PDUs may include decompressing the PDUs. Description and examples of processing SDUs to generate PDUs are described further with reference to FIGS. 3C, 3E, and 5.

As indicated, the base station 105 receives the transmitted PDCP PDUs from the UE 115, and optionally begins processing them, while the UE 115 is still transmitting additional PDCP PDUs of the sequence.

At 720, the base station 105 determines a buffer error. For example, the base station 105 while decoding a particular PDCP PDU determines a buffer checksum error. As illustrated in the example of FIG. 7, the base station determines an error with PDCP PDU with serial number 100 (SN 100) (e.g., packet 101) based on a checksum value of PDCP PDU SN 100 not matching a checksum value determined based on the PDCP UDC decompression buffer of the base station 105.

At 725, the base station 105 sends an indication of the buffer error and an indication of a last processed packet by the base station 105 to the UE 115. For example, the base station transmits an enhanced UDC control PDU (e.g., PDU control message 370) which includes an additional field configured to indicate a serial number of last processed packet by the base station 105. As indicated in the example of FIG. 7, at 735, the UE 115 is still transmitting PDCP PDUs of the sequence. For example, the UE 115 is transmitting PDCP PDU SN 101 through PDCP PDU SN 120.

At 730, the base station 105 determines to reset the buffer based on determining the buffer error. For example, the base station 105 clears stored packets in the PDCP PDU decompression buffer and sets buffer values to zeros.

Although resetting the buffer is illustrated as occurring prior to sending the indication of the buffer error to the UE 115 in the example of FIG. 7, in other implementations, the buffer may be reset based on transmitting the indication and occur after 730. When the buffer is reset, the base station 105 may look for an indication that a corresponding buffer (UDC compression buffer) of the UE 115 has been reset. This indication may be provided by UDC data or control PDUs, such as by setting an FE field value to 1.

At 740, the UE 115 receives the buffer error indication and stops transmitting PDCP PDUs. For example, the UE 115 receives the buffer error indication after transmitting PDCP PDU SN 120, but before transmitting PDCP PDU SN 121. The UE 115 may determine to reset the buffer to resynchronize the compression buffer with the decompression buffer of the base station 105 based on receiving the buffer error indication. At 745, the UE 115 resets the compression buffer. For example, the UE 115 clears stored packets in the PDCP PDU compression buffer and sets compression buffer values to zeros.

At 750, after the compression buffer reset, the UE 115 performs continuous retransmission of selected packets not decompressed by the base station 105 based on the buffer error indication and the indication of the last processed packet by the base station 105. For example,

In some implementations, the UE 115 transmits an indication of a compression buffer reset. For example, the UE 115 may transmit a control PDU, such as UDC control PDU separate from a retransmitted data PDU. Alternatively, the UE 115 may transmit the indication of a buffer reset in a first retransmitted UDC data PDU.

As described with reference to FIGS. 4-6B, the UE 115 may have different options or operating modes to select a serial number for these retransmissions. As illustrative examples, the UE 115 may either start up again with a serial number of the last processed PDCP PDU (PDCP PDU SN 100), a next PDCP PDU (PDCP PDU SN 121), or start all over from an initialized value (PDCP PDU 0) depending on the serial number assignment operation mode.

The base station 105 processes (e.g., decompresses/decodes) the received second PDCP PDUs. For example, the base station 105 receives new or retransmitted PDCP PDUs which include or correspond to PDCP PDUs and SDUs of the first PDCP PDUs which were not decompressible. To illustrate, the base station 105 can now decompress PDCP SDUs SN 100-120 and any PDU thereafter (SN 121-SN 200) due to the decompression being backward dependent and the decompression buffer being out of synchronization with a corresponding compression buffer.

FIG. 8 illustrates a block diagram illustrating buffer operations for enhanced buffer resolution operations. In FIG. 8, a PDCP SDU buffer 802 is illustrated and a PDCP PDU buffer 804 is illustrated. The PDCP PDU buffer 804 which corresponds to the PDCP SDU buffer 802 is illustrated at a plurality of points in time, such as a first time (T1), a second time (T2), a third time (T3), and a fourth time (T4). Additionally, multiple versions of the PDCP PDU buffer 804 are illustrated for the fourth time, specifically, a first type PDCP PDU buffer 804a, a second type PDCP PDU buffer 804b, and a third type PDCP PDU buffer 804c.

As illustrated in the example of FIG. 8, the PDCP SDU buffer 802 includes a sequence of packets with serial numbers from 0 to Z. During operation, the PDCP layer may process packets (SDUs) from the PDCP SDU buffer 802. The processed packets may become PDCP PDUs which are temporarily stored in the PDCP PDU buffer 804, such as according to a timer.

In the example of FIG. 8, the first time (T1) may correspond to a point in time when the UE 115 is transmitting the first plurality of PDCP PDUs and before and error is detected or indication. The second time (T2) may correspond to a point in time when the UE 115 is transmitting the first plurality of PDCP PDUs and an error has occurred, but the error is not yet indicated to the UE 115. The third time (T3) may correspond to a point in time when the error indication has been received and the UE 115 has reset (e.g., emptied) its buffer. The fourth time (T4) may correspond to a point in time when the UE 115 is transmitting the second plurality of PDCP PDUs.

At the first time (T1), the PDCP PDU buffer 804 includes a plurality of first PDCP PDUs, such as PDUs 0-Y. The plurality of first PDCP PDUs correspond to the first PDCP PDUs transmitted before an error is indicated. Each PDU may be generated based on a corresponding SDU of the same value, such as SDU 0 is compressed to generate PDU 0, SDU 1 is compressed to generate PDU 1, and so on.

At the second time (T2), the PDCP PDU buffer 804 includes a plurality of second PDCP PDUs, such as PDUs X+1 to Y. The plurality of second PDCP PDUs may correspond to the first PDCP PDUs of FIG. 7 which are transmitted after an error occurs but before an error is indicated. Each PDU of the second PDUs may be generated based on a corresponding SDU of the same value, such as SDU X+1 is compressed to generate PDU X+1, SDU Y is compressed to generate PDU Y, and so on.

At the third time (T3), the PDCP PDU buffer 804 is empty. For example, any of the first or second PDUs remaining in the PDCP PDU buffer 804 are cleared. In some implementations, the PDCP PDU buffer 804 at the second time additionally includes PDUs, such as PDUs Y+1−Z. In such implementations, these PDUs which have not been transmitted but have been processed (e.g., shown in dashed lines) may be cleared from the PDCP PDU buffer 804 during a reset.

At the fourth time (T4), the first type PDCP PDU buffer 804a includes a plurality of third PDCP PDUs with serial numbers starting from X. The plurality of third PDCP PDUs correspond to the second PDCP PDUs which are retransmitted after the buffer has been reset to resolve the buffer error. When operating in unique PDCP PDU SN mode (or a 1 to 1 SDU SN to PDU SN mode), the UE 115 may renumber the transmitted and undecompressible PDCP SDUs with the same PDCP PDU number as in the first plurality or second plurality of PDUs and place them in the buffer.

For example, when X=100, Y=120, and Z=200, and when the initial error occurred at packet X and a last packet transmitted was Y−1, the UE 115 may populate the first type PDCP PDU buffer 804a starting from PDU X. To illustrate, the UE 115 may generate PDU X based on SDU X. The UE 115 may generate PDUs X+1 to PDU Z based on SDUs X+1 to Z. Thus, for these examples, X−1 is a last processed packet (e.g., most recently processed packet), X is the error or indicated packet, Y−1 is the last transmitted packet, and Y is a HOL packet.

At the fourth time (T4), the second type PDCP PDU buffer 804b includes a plurality of third PDCP PDUs with serial numbers starting from Y. When operating in a HOL or current PDCP mode, the UE 115 may set the serial numbers of the third PDCP PDUs based on a next packet in line to be transmitted (e.g., a value incremented from a last PDCP sent).

For example, when X=100, Y=120, and Z=200, and when the initial error occurred at packet X and a last packet transmitted was Y−1, the UE 115 may populate the second type PDCP PDU buffer 804b starting from PDU Y. To illustrate, the UE 115 may generate PDU Y based on SDU X. The UE 115 may generate PDUs Y+1 to PDU Z+(Y−X) based on SDUs X+1 to Z.

At the fourth time (T4), the third type PDCP PDU buffer 804c includes a plurality of third PDCP PDUs with serial numbers starting from zero (0). When operating in a reset PDCP mode, the UE 115 may reset the TX_NEXT value and then set the serial numbers of the third PDCP PDUs based on the reset TX_NEXT value.

For example, when X=100, Y=120, and Z=200, and when the initial error occurred at packet X and a last packet transmitted was Y−1, the UE 115 may populate the third type PDCP PDU buffer 804c starting from PDU 0. To illustrate, the UE 115 may generate PDU 0 based on SDU X. The UE 115 may generate PDUs 1 to PDU Z−X based on SDUs X+1 to Z.

The PDCP PDUs of the plurality of PDUs have a backward decoding dependency. For example, PDU 100 has backward decoding dependency based on PDU 99, PDU 99 has backward decoding dependency based on PDU 98, and so on down to PDU 0. Similarly, PDU 200 has backward decoding dependency based on PDU 199, PDU 199 has backward decoding dependency based on PDU 198, and so on down to PDU 0 (unless an error breaks the chain).

However, a first PDU after a buffer reset may have no backward decoding dependency. For example, the first or initial transmission (retransmission of SDU X) of the third plurality of PDCP PDUs may not have backward decoding dependency. To illustrate, the first or initial transmission (retransmission of SDU X) of the third plurality of PDCP PDU is not backward decoding dependent on the initial transmission of PDU X/SDU X of the first plurality of transmissions or the last received transmission of PDU Y−1/SDU Y−1.

As explained above, all subsequent transmissions (retransmissions of SDU X+1−Z) after the first or initial transmission (retransmission of SDU X, such as PDU X in buffer 804a, PDU Y in buffer 804b, or PDU 0 in buffer 804c) of the third plurality of PDCP PDUs have backward decoding dependency. For example, a PDCP PDU X+1 (including SDU X+1) has backward decoding dependency based on PDU X (the first or initial transmission), all the way up to PDU Z (including SDU Z) having backward decoding dependency based on PDU Z−1. As another example, a PDCP PDU Y+1 (including SDU X+1) has backward decoding dependency based on PDU Y (the first or initial transmission), all the way up to PDU Z−(Y+Z) (including SDU Z) having backward decoding dependency based on PDU Z−(Y+Z)−1. As yet another example, a PDCP PDU 1 (including SDU X+1) has backward decoding dependency based on PDU 0 (the first or initial transmission), all the way up to PDU Z−X (including SDU Z) having backward decoding dependency based on PDU Z−X−1.

This initial transmission (SDU X) of the third plurality of PDCP PDUs is a retransmission of a particular transmission (SDU X) of the first plurality of PDCP PDUs. The retransmission PDU of the third plurality of PDCP PDUs is different from the original transmission of the first plurality of PDCP PDUs in at least backward decoding dependency. To illustrate, the initial retransmission (PDU with SDU X) of the third plurality of PDUs does not have backward decoding dependency while the transmission of SDU X in the first plurality of PDUs has backward decoding dependency, but an error occurred (e.g., broken backward decoding dependency). The initial retransmission (PDU with SDU X) of the third plurality of PDUs may have no decoding dependency (e.g., a blank or empty decoding dictionary). The PDUs may have other differences, such as a different serial number, as described herein.

To further illustrate backward decoding dependency (e.g., PDCP layer backward decoding dependency), the PDCP SDUs have no PDCP decoding dependencies, whether upon a first occurrence transmission or retransmission. Similarity, non-UDC PDCP PDUs have no PDCP decoding dependencies.

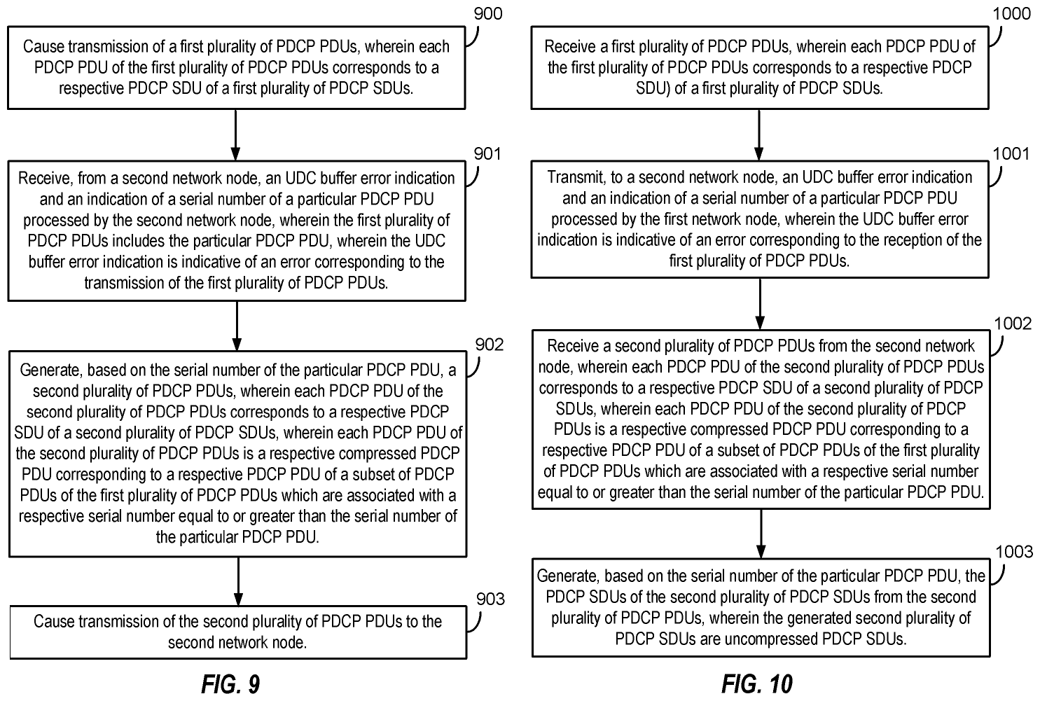

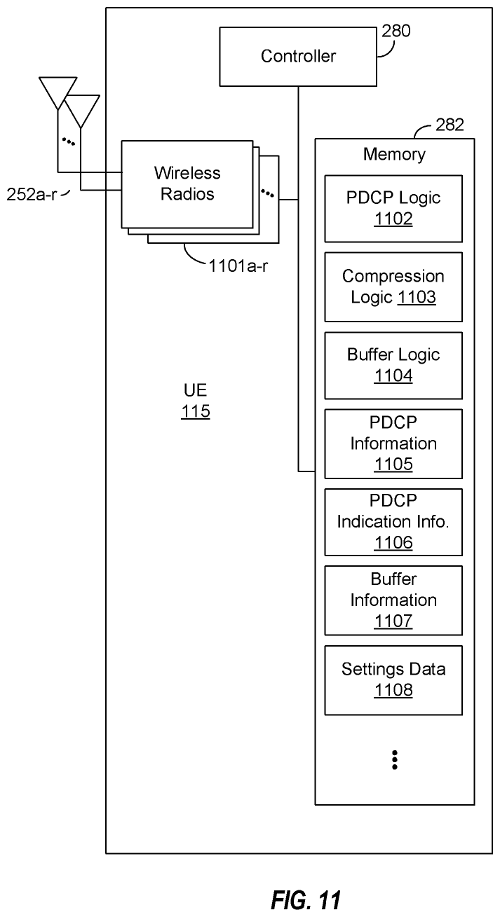

FIG. 9 is a flow diagram illustrating example blocks executed by a wireless communication device (e.g., a UE or base station) configured according to an aspect of the present disclosure. The example blocks will also be described with respect to UE 115 as illustrated in FIG. 11. FIG. 11 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1101a-r and antennas 252a-r. Wireless radios 1101a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 11, memory 282 stores PDCP logic 1102, decompression logic 1103, buffer logic 1104, PDCP information 1105, PDCP indication information 1106, buffer information 1107, and settings data 1108. The data (1102-1108) stored in the memory 282 may include or correspond to the data (406, 408, 442, and/or 444) stored in the memory 404 of FIG. 4.

At block 900, a wireless communication device, such as a UE, causes transmission of a first plurality of Packet Data Convergence Protocol (PDCP) Protocol Data Units (PDUs), wherein each PDCP PDU of the first plurality of PDCP PDUs corresponds to a respective PDCP Service Data Unit (SDU) of a first plurality of PDCP SDUs. For example, the UE (e.g., UE 115) may transmit the first transmissions 452 of FIG. 4, the first PDCP PDUs of FIG. 7 (e.g., between 715 and 750), or the first plurality of PDUs of FIG. 8, as described with reference to FIGS. 4, 7 and 8. To illustrate, a transmitter (e.g., transmit processor 264 or transmitter 410) of the UE 115 transmits the first transmissions 452 via wireless radios 1101a-r and antennas 252a-r. The transmission of the first plurality of PDUs may include or correspond to transmission over the air (e.g., physical interface or lowest layer), or at a particular higher layer, such as from a PDCP layer to a RLC layer of the UE 115. The first plurality of PDCP PDUs and SDUs may include or correspond to application data, such as music data, video data, etc. The PDUs may include compressed payload data and may be generated based on UDC processing.

At block 901, the wireless communication device receives, from a second network node, an uplink data compression (UDC) buffer error indication and an indication of a serial number of a particular PDCP PDU processed by the second network node, wherein the first plurality of PDCP PDUs includes the particular PDCP PDU, wherein the UDC buffer error indication is indicative of an error corresponding to the transmission of the first plurality of PDCP PDUs. For example, the UE 115 receive the indication 454 of FIG. 4 or the indications at 725 of FIG. 7 from the base station 105, as described with reference to FIGS. 4 and 7. To illustrate, a receiver (e.g., receiver processor 258 or receiver 412) of the UE 115 receives a UDC control PDU (e.g., 370) via wireless radios 1101a-r and antennas 252a-r which indicates a buffer error and a serial number of a last packet processed or of a packet that experienced an error.

At block 902, the wireless communication device generates, based on the serial number of the particular PDCP PDU, a second plurality of PDCP PDUs, wherein each PDCP PDU of the second plurality of PDCP PDUs corresponds to a respective PDCP SDU of a second plurality of PDCP SDUs, wherein each PDCP PDU of the second plurality of PDCP PDUs is a respective compressed PDCP PDU corresponding to a respective PDCP PDU of a subset of PDCP PDUs of the first plurality of PDCP PDUs which are associated with a respective serial number equal to or greater than the serial number of the particular PDCP PDU. For example, the UE 115 may generate, based on the serial number of the PDU indicated (e.g., error PDU), the PDCP PDUs of the second plurality of PDCP PDUs from the second plurality of PDCP SDUs, as described with reference to FIGS. 5 and 6. To illustrate, a PDCP layer or logic of the UE 115 processes the SDUs of the second plurality of SDUs as described with reference to FIGS. 3E, 5, or 8. The second PDUs may include compressed payload data and may be generated based on UDC processing.

At block 903, the wireless communication device causes transmission of the second plurality of PDCP PDUs to the second network node. For example, the UE 115 may transmit the second transmissions 456 of FIG. 4, the second PDCP PDUs of FIG. 7, or the third plurality of PDUs of FIG. 8, as described with reference to FIGS. 4, 7 and 8. To illustrate, a transmitter (e.g., transmit processor 264 or transmitter 410) of the UE 115 transmits the second transmissions 456 (including second PDUs) via wireless radios 1101a-r and antennas 252a-r. The transmission of the second plurality of PDUs may include or correspond to transmission over the air (e.g., physical interface or lowest layer), or at a particular higher layer, such as from a PDCP layer to a RLC layer of the UE 115. The second PDCP PDUs and SDUs may include or correspond to application data, such as music data, video data, etc.

The wireless communication device (e.g., UE or base station) may execute additional blocks (or the wireless communication device may be configured further perform additional operations) in other implementations. For example, the wireless communication device (e.g., the UE 115) may perform one or more operations described above, such as described with reference to FIGS. 4-8. As another example, the wireless communication device (e.g., the UE 115) may perform one or more aspects as presented below.

In a first aspect, the particular PDCP PDU processed by the second network node is a last processed PDCP PDU of the first plurality of PDCP PDUs.

In a second aspect, alone or in combination with the first aspect, transmission of each respective PDCP PDU of the second plurality of PDCP PDUs constitutes retransmission of the respective PDCP PDUs of the first plurality of PDCP with which each respective PDCP PDU of the second plurality of PDCP PDUs is associated.

In a third aspect, alone or in combination with one or more of the above aspects, to generate the second plurality of PDCP PDUs, the first network node generates the second plurality of PDCP PDUs at a first layer, and wherein, to cause transmission of the second plurality of PDCP PDUs to the second network node, and the first network node further: provides the second plurality of PDCP PDUs to a second layer for processing before transmission of the second plurality of PDCP PDUs, wherein the second layer is lower than the first layer; or transmits the second plurality of PDCP PDUs to the second network node.

In a fourth aspect, alone or in combination with one or more of the above aspects, to cause transmission of the first plurality of PDCP PDUs to the second network node, the first network node: provides the first plurality of PDCP PDUs to the second layer for processing before transmission of the first plurality of PDCP PDUs, wherein the second layer is lower than the first layer; or transmits the first plurality of PDCP PDUs to the second network node.

In a fifth aspect, alone or in combination with one or more of the above aspects, the first layer is a PDCP layer and the second layer is a RLC layer.

In a sixth aspect, alone or in combination with one or more of the above aspects, the second plurality of PDCP SDUs includes one or more PDCP SDUs of the first plurality of PDCP SDUs, wherein the one or more PDCP SDUs correspond to respective PDCP PDUs of the subset of PDCP PDUs of the first plurality of PDCP PDUs.

In a seventh aspect, alone or in combination with one or more of the above aspects, the particular PDCP PDU of the first plurality of PDUs has a backward decoding dependency, and wherein a particular PDCP PDU of the second plurality of PDCP PDUs that corresponds to the particular PDCP PDU of the first plurality of PDUs has no backward decoding dependency.

In an eighth aspect, alone or in combination with one or more of the above aspects, the particular PDCP PDU of the second plurality of PDCP PDUs that corresponds to the particular PDCP PDU of the first plurality of PDUs is configured to be transmitted before transmission of any respective PDCP PDU of a subset of PDCP PDUs of the second plurality of PDCP PDUs, the subset of PDCP PDUs of the second plurality of PDCP PDUs includes each PDCP PDU of the second plurality of PDUs except for the particular PDCP PDU of the second plurality of PDCP PDUs that corresponds to the particular PDCP PDU of the first plurality of PDUs, and each respective PDCP PDU of the subset of PDCP PDUs of the second plurality of PDCP PDUs is configured to be transmitted after transmission of the particular PDCP PDU of the second plurality of PDCP PDUs that corresponds to the particular PDCP PDU of the first plurality of PDUs.

In a ninth aspect, alone or in combination with one or more of the above aspects, each respective PDCP PDU of the subset of PDCP PDUs of the second plurality of PDCP PDUs has a respective backward decoding dependency based on a respective PDCP PDU of the second plurality of PDCP PDUs.

In a tenth aspect, alone or in combination with one or more of the above aspects, to receive the UDC buffer error indication, the first network node receives a UDC control PDU indicating a buffer checksum error and the serial number of the particular PDCP PDU.

In an eleventh aspect, alone or in combination with one or more of the above aspects, the first network node further resets a UDC compression buffer based on the UDC buffer error indication.

In a twelfth aspect, alone or in combination with one or more of the above aspects, to reset the UDC compression buffer, the first network node discards stored PDCP PDUs of the first plurality of PDCP PDUs or stored PDCP PDUs which correspond to PDCP SDUs of the second plurality of SDUs in the UDC compression buffer based on the reset of the UDC compression buffer.

In a thirteenth aspect, alone or in combination with one or more of the above aspects, to generate the second plurality of PDCP PDUs, the first network node: determines an initial PDCP SDU of the second plurality of PDCP SDUs based on the serial number of the particular PDCP PDU of the first plurality of PDCP PDUs; compresses the initial PDCP SDU of the second plurality of PDCP SDUs to generate a compressed initial PDCP PDU, wherein the compressed initial PDCP PDU of the second plurality of PDCP PDUs is configured to be transmitted before any other PDCP PDU of the second plurality of PDUs; and sets a serial number of the compressed initial PDCP PDU.

In a fourteenth aspect, alone or in combination with one or more of the above aspects, the serial number of the compressed initial PDCP PDU is the same as the serial number of the particular PDCP PDU of the first plurality of PDCP PDUs.

In a fifteenth aspect, alone or in combination with one or more of the above aspects, the serial number of the compressed initial PDCP PDU is different than the serial number of the particular PDCP PDU of the first plurality of PDCP PDUs.

In a sixteenth aspect, alone or in combination with one or more of the above aspects, the serial number of the compressed initial PDCP PDU is less than or greater than the serial number of the particular PDCP PDU of the first plurality of PDCP PDUs. Is some implementations, the serial number of the compressed initial PDCP PDU is greater than the serial number of the particular PDCP PDU of the first plurality of PDCP PDUs.

In a seventeenth aspect, alone or in combination with one or more of the above aspects, a particular PDCP PDU of the second plurality of PDCP PDUs corresponds to the initial PDCP SDU of the second plurality of PDCP SDUs, and wherein the particular PDCP PDU of the second plurality of PDCP PDUs corresponds to the particular PDCP PDU of the first plurality of PDUs.

In an eighteenth aspect, alone or in combination with one or more of the above aspects, to set the serial number of the compressed initial PDCP PDU, the first network node sets the serial number of the compressed initial PDCP PDU to a TX_NEXT value, wherein the TX_NEXT value corresponds to a head of line (HOL) value, wherein the HOL value corresponds to a serial number subsequent to a serial number of a last transmitted PDCP PDU of the first plurality of PDCP PDUs before the receipt of the UDC buffer error indication.

In a nineteenth aspect, alone or in combination with one or more of the above aspects, the serial number of the compressed initial PDCP PDU corresponds to a serial number subsequent to a serial number of a last transmitted PDCP PDU of the first plurality of PDCP PDUs before receipt of the UDC buffer error indication.

In a twentieth aspect, alone or in combination with one or more of the above aspects, to set the serial number of the compressed initial PDCP PDU, the first network node: sets a TX_NEXT value to an initial value; and sets the serial number of the of the compressed initial PDCP PDU to TX_NEXT value.

In a twenty-first aspect, alone or in combination with one or more of the above aspects, the serial number of the compressed initial PDCP PDU is an initial value of TX_NEXT.

In a twenty-second aspect, alone or in combination with one or more of the above aspects, an initial PDCP PDU of the second plurality of PDCP SDUs is based on the serial number of the particular PDCP PDU of the first plurality of PDCP PDUs, wherein the initial PDCP PDU is a respective compressed PDCP PDU corresponding to the particular PDCP of the first plurality of PDUs, and wherein the initial PDCP PDU is associated with a serial number that is the same as or different from the serial number of the particular PDCP PDU of the first plurality of PDCP PDUs.

In a twenty-third aspect, alone or in combination with one or more of the above aspects, a serial number of an initial PDCP PDU of the second plurality of PDCP PDUs is the same as the serial number of the particular PDCP PDU of the first plurality of PDUs, wherein the initial PDCP PDU of the second plurality of PDUs is configured to be transmitted before any other PDCP PDU of the second plurality of PDUs, and wherein the particular PDCP PDU processed by the second network node is a last processed PDCP PDU of the first plurality of PDCP PDUs.

In a twenty-fourth aspect, alone or in combination with one or more of the above aspects, a serial number of an initial PDCP PDU of the second plurality of PDCP PDUs is the same as a serial number of a last transmitted PDCP PDU of the first plurality of PDCP PDUs, wherein the initial PDCP PDU of the second plurality of PDCP PDUs is configured to be transmitted before any other PDCP PDU of the second plurality of PDCP PDUs.

In a twenty-fifth aspect, alone or in combination with one or more of the above aspects, a serial number of an initial PDCP PDU of the second plurality of PDCP PDUs is one value greater than a serial number of a last transmitted PDCP PDU of the first plurality of PDCP PDUs, wherein the initial PDCP PDU of the second plurality of PDCP PDUs is configured to be transmitted before any other PDCP PDU of the second plurality of PDCP PDUs.

In a twenty-sixth aspect, alone or in combination with one or more of the above aspects, a serial number of an initial PDCP PDU of the second plurality of PDCP PDUs is one value greater than the serial number of the particular PDCP PDU of the first plurality of PDCP PDUs, wherein the particular PDCP PDU processed by the second network node is a last processed PDCP PDU of the first plurality of PDCP PDUs, wherein the initial PDCP PDU of the second plurality of PDCP PDUs is configured to be transmitted before any other PDCP PDU of the second plurality of PDCP PDUs.

In a twenty-seventh aspect, alone or in combination with one or more of the above aspects, a serial number of an initial PDCP PDU of the second plurality of PDCP PDUs is zero, wherein the initial PDCP PDU of the second plurality of PDCP PDUs is configured to be transmitted before any other PDCP PDU of the second plurality of PDCP PDUs.

In a twenty-eighth aspect, alone or in combination with one or more of the above aspects, the error corresponding to the transmission of the first plurality of PDCP PDUs indicates that the second network node determined a UDC checksum error for the particular PDCP PDU of the first plurality of PDCP PDUs with a serial number indicated in a received control PDU.

In a twenty-ninth aspect, alone or in combination with one or more of the above aspects, the error corresponding to the transmission of the first plurality of PDCP PDUs is indicative of a UDC checksum error.

In a thirtieth aspect, alone or in combination with one or more of the above aspects, the error corresponding to the transmission of the first plurality of PDCP PDUs indicates that a compression buffer of the first network node and a decompression buffer of the second network node are out of synchronization.

In a thirty-first aspect, alone or in combination with one or more of the above aspects, resynchronize the compression buffer of the first network node with the decompression buffer of the second network node.

Accordingly, wireless communication devices may perform improved buffer error resolution operations for wireless communication devices. By performing improved buffer error resolution operations, such as continuous retransmission, throughput can be increased and latency can be reduced.

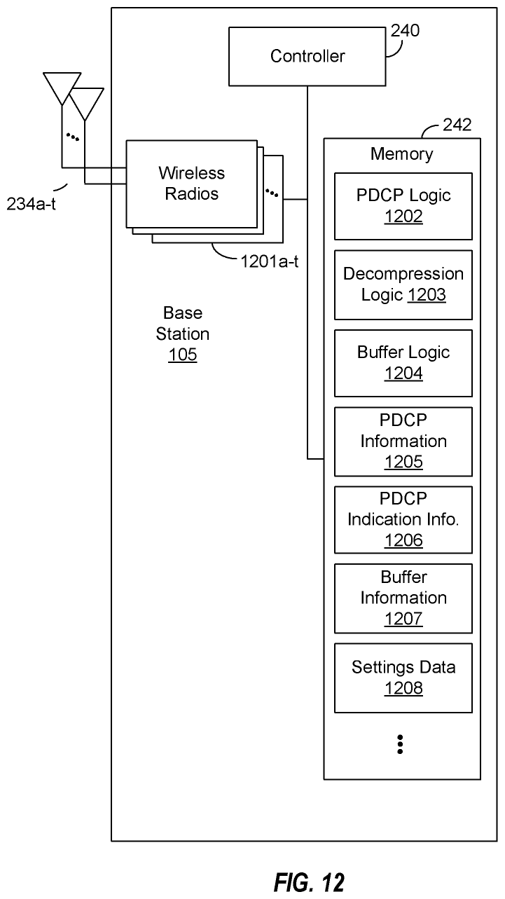

FIG. 10 is a flow diagram illustrating example blocks executed wireless communication device (e.g., a UE or network entity, such as a base station) configured according to an aspect of the present disclosure. The example blocks will also be described with respect to base station 105 as illustrated in FIG. 12. FIG. 12 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1201a-t and antennas 234a-t. Wireless radios 1201a-t includes various components and hardware, as illustrated in FIG. 2 for base station 105, including modulator/demodulators 232a-r, MIMO detector 236, receive processor 238, transmit processor 220, and TX MIMO processor 230. As illustrated in the example of FIG. 12, memory 242 stores PDCP logic 1202, decompression logic 1203, buffer logic 1204, PDCP information 1205, PDCP indication information 1206, buffer information 1207, and settings data 1208. The data (1202-1208) stored in the memory 242 may include or correspond to the data (406, 408, 442, and/or 444) stored in the memory 432 of FIG. 4.

At block 1000, a wireless communication device, such as a network device (e.g., a base station 105), receives a first plurality of Packet Data Convergence Protocol (PDCP) Protocol Data Units (PDUs), wherein each PDCP PDU of the first plurality of PDCP PDUs corresponds to a respective PDCP Service Data Unit (SDU) of a first plurality of PDCP SDUs. For example, the base station 105 may receive the first transmissions 452 of FIG. 4, the first PDCP PDUs of FIG. 7 (e.g., between 715 and 750), or the first plurality of PDUs of FIG. 8, as described with reference to FIGS. 4, 7 and 8. To illustrate, a receiver (e.g., receiver processor 238 or receiver 436) of the base station 105 receives the first transmissions 452 via wireless radios 1201a-t and antennas 234a-t. The reception of the first plurality of PDUs may include or correspond to reception over the air (e.g., physical interface or lowest layer), or at a particular higher layer, such as a PDCP layer, of the base station 105. The first plurality of PDCP PDUs and SDUs may include or correspond to application data, such as music data, video data, etc. The PDUs may include compressed payload data and may be generated based on UDC processing.

At block 1001, the wireless communication device transmits, to a second network node, an uplink data compression (UDC) buffer error indication and an indication of a serial number of a particular PDCP PDU processed by the first network node, wherein the UDC buffer error indication is indicative of an error corresponding to the reception of the first plurality of PDCP PDUs. For example, the base station 105 may transmit the indication 454 of FIG. 4 or the indications at 725 of FIG. 7 to the UE 115 as described with reference to FIGS. 4 and 7. To illustrate, a transmitter (e.g., transmit processor 220/TX MIMO processor 230 or transmitter 434) of the base station 105 transmits a UDC control PDU (e.g., 370) via wireless radios 1201a-t and antennas 234a-t which indicates a buffer error and a serial number of a last packet processed or of a packet that experienced an error.

At block 1002, the wireless communication device receives a second plurality of PDCP PDUs from the second network node, wherein each PDCP PDU of the second plurality of PDCP PDUs corresponds to a respective PDCP SDU of a second plurality of PDCP SDUs, wherein each PDCP PDU of the second plurality of PDCP PDUs is a respective compressed PDCP PDU corresponding to a respective PDCP PDU of a subset of PDCP PDUs of the first plurality of PDCP PDUs which are associated with a respective serial number equal to or greater than the serial number of the particular PDCP PDU. For example, the base station 105 may receive the second transmissions 456 of FIG. 4, the second PDCP PDUs of FIG. 7, or the third plurality of PDUs of FIG. 8, as described with reference to FIGS. 4, 7 and 8. To illustrate, a receiver (e.g., receiver processor 238 or receiver 436) of the base station 105 receives the second transmissions 456 (including second PDUs) via wireless radios 1201a-t and antennas 234a-t. The reception of the second PDUs may include or correspond to reception over the air (e.g., physical interface or lowest layer), or at a particular higher layer, such as a PDCP layer, of the base station 105. The second PDCP PDUs and SDUs may include or correspond to application data, such as music data, video data, etc. The second PDUs may include compressed payload data and may be generated based on UDC processing.

At block 1003, the wireless communication device generates, based on the serial number of the particular PDCP PDU, the PDCP SDUs of the second plurality of PDCP SDUs from the second plurality of PDCP PDUs, wherein the generated second plurality of PDCP SDUs are uncompressed PDCP SDUs. For example, the base station 105 may generate, based on the serial number of the PDU indicated (e.g., error PDU), the PDCP SDUs of the second plurality of PDCP SDUs from the second plurality of PDCP PDUs, as described with reference to FIGS. 5 and 6. To illustrate, a PDCP layer or logic of the base station 105 processes the receives PDUs of the second plurality of transmissions as described with reference to FIGS. 3E or 5. The reception of the second PDUs may include or correspond to reception over the air (e.g., physical interface or lowest layer), or at a particular higher layer, such as a PDCP layer, of the base station 105. The second PDCP PDUs and SDUs may include or correspond to application data, such as music data, video data, etc. The second SDUs may include decompressed payload data and may be generated based on UDC processing.

The wireless communication device (e.g., such as a UE or base station) may execute additional blocks (or the wireless communication device may be configured further perform additional operations) in other implementations. For example, the wireless communication device may perform one or more operations as described with reference to FIGS. 4-8. As another example, the wireless communication device may perform one or more aspects as described above with reference to FIG. 9.

In a first aspect, the first network node determines a buffer checksum error based on a decompression buffer and a checksum value of the particular PDCP PDU, wherein the UDC buffer error indication is transmitted based on the determination of the buffer checksum error.

In a second aspect, alone or in combination with the first aspect, to generate the second plurality of PDCP SDUs, the first network node generates the second plurality of PDCP SDUs at a first layer, and the first network node further transmits an indication to a second layer to stop delivering received second layer SDUs to the first layer based on the determination of the buffer checksum error.

In a third aspect, alone or in combination with one or more of the above aspects, the second layer is lower than the first layer.

In a fourth aspect, alone or in combination with one or more of the above aspects, the first layer is a PDCP layer and the second layer is a RLC layer.

In a fifth aspect, alone or in combination with one or more of the above aspects, the first network node further refrains, by the second layer thereof, from reporting an acknowledgment for the second layer SDUs not delivered to the first layer to the second network node.

In a sixth aspect, alone or in combination with one or more of the above aspects, the error indicates to perform retransmission of all PDCP SDUs with a count value that satisfies a retransmission condition in ascending order of the count values associated to each PDCP SDU, wherein the retransmission condition is based on count values which have a serial number greater than the serial number of the particular PDCP PDU.

In a seventh aspect, alone or in combination with one or more of the above aspects, the particular PDCP PDU processed by the first network node is a last processed PDCP PDU of the first plurality of PDCP PDUs.

In an eighth aspect, alone or in combination with one or more of the above aspects, the particular PDCP PDU of the first plurality of PDUs has a backward decoding dependency, and wherein a particular PDCP PDU of the second plurality of PDCP PDUs that corresponds to the particular PDCP PDU of the first plurality of PDUs has no backward decoding dependency.

In a ninth aspect, alone or in combination with one or more of the above aspects, the particular PDCP PDU of the second plurality of PDCP PDUs that corresponds to the particular PDCP PDU of the first plurality of PDUs is received before any respective PDCP PDU of a subset of PDCP PDUs of the second plurality of PDCP PDUs, the subset of PDCP PDUs of the second plurality of PDCP PDUs includes each PDCP PDU of the second plurality of PDUs except for the particular PDCP PDU of the second plurality of PDCP PDUs that corresponds to the particular PDCP PDU of the first plurality of PDUs, and each respective PDCP PDU of the subset of PDCP PDUs of the second plurality of PDCP PDUs is received after reception of the particular PDCP PDU of the second plurality of PDCP PDUs that corresponds to the particular PDCP PDU of the first plurality of PDUs.

In a tenth aspect, alone or in combination with one or more of the above aspects, each respective PDCP PDU of the subset of PDCP PDUs of the second plurality of PDCP PDUs has a respective backward decoding dependency based on a respective PDCP PDU of the second plurality of PDCP PDUs.

In an eleventh aspect, alone or in combination with one or more of the above aspects, to receive the UDC buffer error indication, the first network node transmits a UDC control PDU indicating a buffer checksum error and the serial number of the particular PDCP PDU.

In a twelfth aspect, alone or in combination with one or more of the above aspects the first network node further resets a UDC decompression buffer based on the UDC buffer error indication.

In a thirteenth aspect, alone or in combination with one or more of the above aspects, to reset the UDC decompression buffer, the first network node discards stored PDCP PDUs of the first plurality of PDCP PDUs or stored PDCP PDUs which correspond to PDCP SDUs of the second plurality of SDUs in the UDC decompression buffer based on the reset of the UDC decompression buffer.

In a fourteenth aspect, alone or in combination with one or more of the above aspects, to generate the second plurality of PDCP SDUs, the first network node generates the second plurality of PDCP PDUs at a first layer, and the first network node further provides the second plurality of PDCP SDUs to a third layer for processing, wherein the third layer is higher than the first layer.

In a fifteenth aspect, alone or in combination with one or more of the above aspects, to receive the second plurality of PDCP PDUs, the first network node receives the second plurality of PDCP PDUs from a second layer for processing before generation of the second plurality of PDCP SDUs, wherein the second layer is lower than the first layer.

In a sixteenth aspect, alone or in combination with one or more of the above aspects, to generate the second plurality of PDCP SDUs, the first network node: determines an initial PDCP PDU of the second plurality of PDCP PDUs based on the serial number of the particular PDCP PDU of the first plurality of PDCP PDUs, wherein the initial PDCP PDU of the second plurality of PDUs is received before any other PDCP PDU of the second plurality of PDUs; decompresses the initial PDCP PDU of the second plurality of PDCP PDUs to generate a decompressed initial PDCP SDU; and sets a serial number of the decompressed initial PDCP SDU.

In a seventeenth aspect, alone or in combination with one or more of the above aspects, the serial number of the decompressed initial PDCP SDU corresponds to a serial number subsequent to a serial number of a last received PDCP SDU of the first plurality of PDCP SDUs before transmission of the UDC buffer error indication.

In an eighteenth aspect, alone or in combination with one or more of the above aspects, the serial number of the decompressed initial PDCP SDU is an initial value of TX_NEXT.

In a nineteenth aspect, alone or in combination with one or more of the above aspects, a serial number of an initial PDCP PDU of the second plurality of PDCP PDUs is the same as the serial number of the particular PDCP PDU of the first plurality of PDUs, wherein the initial PDCP PDU of the second plurality of PDUs is received before any other PDCP PDU of the second plurality of PDUs, and wherein the particular PDCP PDU processed by the first network node is a last processed PDCP PDU of the first plurality of PDCP PDUs.

In a twentieth aspect, alone or in combination with one or more of the above aspects, a serial number of an initial PDCP PDU of the second plurality of PDCP PDUs is the same as a serial number of a last received PDCP PDU of the first plurality of PDCP PDUs, wherein the initial PDCP PDU of the second plurality of PDCP PDUs is received before any other PDCP PDU of the second plurality of PDCP PDUs.

In a twenty-first aspect, alone or in combination with one or more of the above aspects, a serial number of an initial PDCP PDU of the second plurality of PDCP PDUs is one value greater than a serial number of a last received PDCP PDU of the first plurality of PDCP PDUs, wherein the initial PDCP PDU of the second plurality of PDCP PDUs is received before any other PDCP PDU of the second plurality of PDCP PDUs.

In a twenty-second aspect, alone or in combination with one or more of the above aspects, a serial number of an initial PDCP PDU of the second plurality of PDCP PDUs is one value greater than the serial number of the particular PDCP PDU of the first plurality of PDCP PDUs, wherein the particular PDCP PDU processed by the first network node is a last processed PDCP PDU of the first plurality of PDCP PDUs, wherein the initial PDCP PDU of the second plurality of PDCP PDUs is received before any other PDCP PDU of the second plurality of PDCP PDUs.

In a twenty-third aspect, alone or in combination with one or more of the above aspects, a serial number of an initial PDCP PDU of the second plurality of PDCP PDUs is zero, wherein the initial PDCP PDU of the second plurality of PDCP PDUs is received before any other PDCP PDU of the second plurality of PDCP PDUs.

In a twenty-fourth aspect, alone or in combination with one or more of the above aspects, the error corresponding to the reception of the first plurality of PDCP PDUs indicates that the first network node determined a UDC checksum error for the particular PDCP PDU of the first plurality of PDCP PDUs with a serial number indicated in a transmitted control PDU.

In a twenty-fifth aspect, alone or in combination with one or more of the above aspects, the error corresponding to the reception of the first plurality of PDCP PDUs is indicative of a UDC checksum error.

In a twenty-sixth aspect, alone or in combination with one or more of the above aspects, the error corresponding to the reception of the first plurality of PDCP PDUs indicates that a decompression buffer of the first network node and a compression buffer of the second network node are out of synchronization.

In a twenty-seventh aspect, alone or in combination with one or more of the above aspects, the first network node further resynchronizes the decompression buffer of the first network node with the compression buffer of the second network node.

Accordingly, wireless communication devices may perform improved buffer error resolution operations for wireless communication devices. By performing improved buffer error resolution operations, such as continuous retransmission, throughput can be increased and latency can be reduced.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A first network node for wireless communication, comprising:
at least one processor; and
a memory coupled to the at least one processor,
wherein the at least one processor is configured to:
cause transmission of a first plurality of Packet Data Convergence Protocol (PDCP) Protocol Data Units (PDUs), wherein each PDCP PDU of the first plurality of PDCP PDUs corresponds to a respective PDCP Service Data Unit (SDU) of a first plurality of PDCP SDUs;
receive, from a second network node, an uplink data compression (UDC) buffer error indication and an indication of a serial number of a particular PDCP PDU processed by the second network node, wherein the first plurality of PDCP PDUs includes the particular PDCP PDU, wherein the UDC buffer error indication is indicative of an error corresponding to the transmission of the first plurality of PDCP PDUs;
generate, based on the serial number of the particular PDCP PDU, a second plurality of PDCP PDUs, wherein each PDCP PDU of the second plurality of PDCP PDUs corresponds to a respective PDCP SDU of a second plurality of PDCP SDUs, wherein each PDCP PDU of the second plurality of PDCP PDUs is a respective compressed PDCP PDU corresponding to a respective PDCP PDU of a subset of PDCP PDUs of the first plurality of PDCP PDUs which are associated with a respective serial number equal to or greater than the serial number of the particular PDCP PDU; and
cause transmission of the second plurality of PDCP PDUs to the second network node.

2. The first network node of claim 1, wherein the particular PDCP PDU processed by the second network node is a last processed PDCP PDU of the first plurality of PDCP PDUs.

3. The first network node of claim 1, wherein transmission of each respective PDCP PDU of the second plurality of PDCP PDUs constitutes retransmission of the respective PDCP PDUs of the first plurality of PDCP with which each respective PDCP PDU of the second plurality of PDCP PDUs is associated.

4. The first network node of claim 1, wherein the second plurality of PDCP SDUs includes one or more PDCP SDUs of the first plurality of PDCP SDUs, and wherein the one or more PDCP SDUs correspond to respective PDCP PDUs of the subset of PDCP PDUs of the first plurality of PDCP PDUs.

5. The first network node of claim 1, wherein the particular PDCP PDU of the first plurality of PDUs has a backward decoding dependency, and wherein a particular PDCP PDU of the second plurality of PDCP PDUs that corresponds to the particular PDCP PDU of the first plurality of PDUs has no backward decoding dependency.

6. The first network node claim 5, wherein:
the particular PDCP PDU of the second plurality of PDCP PDUs that corresponds to the particular PDCP PDU of the first plurality of PDUs is configured to be transmitted before transmission of any respective PDCP PDU of a subset of PDCP PDUs of the second plurality of PDCP PDUs,
the subset of PDCP PDUs of the second plurality of PDCP PDUs includes each PDCP PDU of the second plurality of PDUs except for the particular PDCP PDU of the second plurality of PDCP PDUs that corresponds to the particular PDCP PDU of the first plurality of PDUs, and
each respective PDCP PDU of the subset of PDCP PDUs of the second plurality of PDCP PDUs is configured to be transmitted after transmission of the particular PDCP PDU of the second plurality of PDCP PDUs that corresponds to the particular PDCP PDU of the first plurality of PDUs.

7. The first network node of claim 1, wherein, to receive the UDC buffer error indication, the at least one processor is configured to:
receive a UDC control PDU indicating a buffer checksum error and the serial number of the particular PDCP PDU.

8. The first network node of claim 1, wherein, to generate the second plurality of PDCP PDUs, the at least one processor is configured to:
determine an initial PDCP SDU of the second plurality of PDCP SDUs based on the serial number of the particular PDCP PDU of the first plurality of PDCP PDUs;
compress the initial PDCP SDU of the second plurality of PDCP SDUs to generate a compressed initial PDCP PDU, wherein the compressed initial PDCP PDU of the second plurality of PDCP PDUs is configured to be transmitted before any other PDCP PDU of the second plurality of PDUs; and
set a serial number of the compressed initial PDCP PDU.

9. The first network node of claim 8, wherein the serial number of the compressed initial PDCP PDU is the same as the serial number of the particular PDCP PDU of the first plurality of PDCP PDUs.

10. The first network node of claim 8, wherein the serial number of the compressed initial PDCP PDU is different than the serial number of the particular PDCP PDU of the first plurality of PDCP PDUs.

11. The first network node of claim 10, wherein the serial number of the compressed initial PDCP PDU is less than or greater than the serial number of the particular PDCP PDU of the first plurality of PDCP PDUs.

12. The first network node of claim 8, wherein a particular PDCP PDU of the second plurality of PDCP PDUs corresponds to the initial PDCP SDU of the second plurality of PDCP SDUs, and wherein the particular PDCP PDU of the second plurality of PDCP PDUs corresponds to the particular PDCP PDU of the first plurality of PDUs.

13. The first network node of claim 8, wherein, to set the serial number of the compressed initial PDCP PDU, the at least one processor is configured to:
set the serial number of the compressed initial PDCP PDU to a TX_NEXT value, wherein the TX_NEXT value corresponds to a head of line (HOL) value, wherein the HOL value corresponds to a serial number subsequent to a serial number of a last transmitted PDCP PDU of the first plurality of PDCP PDUs before the receipt of the UDC buffer error indication.

14. The first network node of claim 13, wherein the serial number of the compressed initial PDCP PDU corresponds to a serial number subsequent to a serial number of a last transmitted PDCP PDU of the first plurality of PDCP PDUs before receipt of the UDC buffer error indication.

15. The first network node of claim 8, wherein, to set the serial number of the compressed initial PDCP PDU, the at least one processor is configured to:
set a TX_NEXT value to an initial value; and
set the serial number of the of the compressed initial PDCP PDU to TX_NEXT value.

16. The first network node of claim 8, wherein the serial number of the compressed initial PDCP PDU is an initial value of TX_NEXT.

17. The first network node of claim 1, wherein an initial PDCP PDU of the second plurality of PDCP SDUs is based on the serial number of the particular PDCP PDU of the first plurality of PDCP PDUs, wherein the initial PDCP PDU is a respective compressed PDCP PDU corresponding to the particular PDCP of the first plurality of PDUs, and wherein the initial PDCP PDU is associated with a serial number that is the same as or different from the serial number of the particular PDCP PDU of the first plurality of PDCP PDUs.

18. The first network node of claim 1, wherein a serial number of an initial PDCP PDU of the second plurality of PDCP PDUs is the same as the serial number of the particular PDCP PDU of the first plurality of PDUs, wherein the initial PDCP PDU of the second plurality of PDUs is configured to be transmitted before any other PDCP PDU of the second plurality of PDUs, and wherein the particular PDCP PDU processed by the second network node is a last processed PDCP PDU of the first plurality of PDCP PDUs.

19. The first network node of claim 1, wherein a serial number of an initial PDCP PDU of the second plurality of PDCP PDUs is the same as a serial number of a last transmitted PDCP PDU of the first plurality of PDCP PDUs, wherein the initial PDCP PDU of the second plurality of PDCP PDUs is configured to be transmitted before any other PDCP PDU of the second plurality of PDCP PDUs.

20. The first network node of claim 1, wherein a serial number of an initial PDCP PDU of the second plurality of PDCP PDUs is one value greater than a serial number of a last transmitted PDCP PDU of the first plurality of PDCP PDUs, wherein the initial PDCP PDU of the second plurality of PDCP PDUs is configured to be transmitted before any other PDCP PDU of the second plurality of PDCP PDUs.

21. The first network node of claim 1, wherein a serial number of an initial PDCP PDU of the second plurality of PDCP PDUs is one value greater than the serial number of the particular PDCP PDU of the first plurality of PDCP PDUs, wherein the particular PDCP PDU processed by the second network node is a last processed PDCP PDU of the first plurality of PDCP PDUs, wherein the initial PDCP PDU of the second plurality of PDCP PDUs is configured to be transmitted before any other PDCP PDU of the second plurality of PDCP PDUs.

22. The first network node of claim 1, wherein a serial number of an initial PDCP PDU of the second plurality of PDCP PDUs is zero, wherein the initial PDCP PDU of the second plurality of PDCP PDUs is configured to be transmitted before any other PDCP PDU of the second plurality of PDCP PDUs.

23. The first network node of claim 1, wherein the at least one processor is configured to:
resynchronize a compression buffer of the first network node with a decompression buffer of the second network node.

24. A first network node for wireless communication, comprising:
at least one processor; and
a memory coupled to the at least one processor,
wherein the at least one processor is configured to:
receive a first plurality of Packet Data Convergence Protocol (PDCP) Protocol Data Units (PDUs), wherein each PDCP PDU of the first plurality of PDCP PDUs corresponds to a respective PDCP Service Data Unit (SDU) of a first plurality of PDCP SDUs;
transmit, to a second network node, an uplink data compression (UDC) buffer error indication and an indication of a serial number of a particular PDCP PDU processed by the first network node, wherein the UDC buffer error indication is indicative of an error corresponding to the reception of the first plurality of PDCP PDUs;
receive a second plurality of PDCP PDUs from the second network node, wherein each PDCP PDU of the second plurality of PDCP PDUs corresponds to a respective PDCP SDU of a second plurality of PDCP SDUs, wherein each PDCP PDU of the second plurality of PDCP PDUs is a respective compressed PDCP PDU corresponding to a respective PDCP PDU of a subset of PDCP PDUs of the first plurality of PDCP PDUs which are associated with a respective serial number equal to or greater than the serial number of the particular PDCP PDU; and
generate, based on the serial number of the particular PDCP PDU, the PDCP SDUs of the second plurality of PDCP SDUs from the second plurality of PDCP PDUs, wherein the generated second plurality of PDCP SDUs are uncompressed PDCP SDUs.

25. The first network node of claim 24, wherein the at least one processor is configured to:
determine a buffer checksum error based on a decompression buffer and a checksum value of the particular PDCP PDU, wherein the UDC buffer error indication is transmitted based on the determination of the buffer checksum error.

26. The first network node of claim 25, wherein, to generate the second plurality of PDCP SDUs, the at least one processor is configured to generate the second plurality of PDCP SDUs at a first layer, wherein the at least one processor is configured to:
transmit an indication to a second layer to stop delivering received second layer SDUs to the first layer based on the determination of the buffer checksum error.

27. The first network node of claim 26, wherein the at least one processor is configured to:
refrain, by the second layer, from reporting an acknowledgment for the second layer SDUs not delivered to the first layer to the second network node.

28. The first network node of claim 24, wherein the error indicates to perform retransmission of all PDCP SDUs with a count value that satisfies a retransmission condition in ascending order of the count values associated to each PDCP SDU, wherein the retransmission condition is based on count values which have a serial number greater than the serial number of the particular PDCP PDU.

29. The first network node of claim 24, wherein the particular PDCP PDU processed by the first network node is a last processed PDCP PDU of the first plurality of PDCP PDUs.

30. The first network node of claim 24, wherein the particular PDCP PDU of the first plurality of PDUs has a backward decoding dependency, and wherein a particular PDCP PDU of the second plurality of PDCP PDUs that corresponds to the particular PDCP PDU of the first plurality of PDUs has no backward decoding dependency.

31. The first network node claim 30, wherein:
the particular PDCP PDU of the second plurality of PDCP PDUs that corresponds to the particular PDCP PDU of the first plurality of PDUs is received before any respective PDCP PDU of a subset of PDCP PDUs of the second plurality of PDCP PDUS,
the subset of PDCP PDUs of the second plurality of PDCP PDUs includes each PDCP PDU of the second plurality of PDUs except for the particular PDCP PDU of the second plurality of PDCP PDUs that corresponds to the particular PDCP PDU of the first plurality of PDUs, and
each respective PDCP PDU of the subset of PDCP PDUs of the second plurality of PDCP PDUs is received after reception of the particular PDCP PDU of the second plurality of PDCP PDUs that corresponds to the particular PDCP PDU of the first plurality of PDUs.

32. The first network node of claim 24, wherein, to receive the UDC buffer error indication, the at least one processor is configured to:
transmit a UDC control PDU indicating a buffer checksum error and the serial number of the particular PDCP PDU.

33. The first network node of claim 24, wherein, to generate the second plurality of PDCP SDUs, the at least one processor is configured to generate the second plurality of PDCP PDUs at a first layer, and wherein the at least one processor is configured to:
provide the second plurality of PDCP SDUs to a third layer for processing, wherein the third layer is higher than the first layer.

34. The first network node of claim 33, wherein, to receive the second plurality of PDCP PDUs, the at least one processor is configured to:
receive the second plurality of PDCP PDUs from a second layer for processing before generation of the second plurality of PDCP SDUs, wherein the second layer is lower than the first layer.

35. The first network node of claim 24, wherein, to generate the second plurality of PDCP SDUs, the at least one processor is configured to:
determine an initial PDCP PDU of the second plurality of PDCP PDUs based on the serial number of the particular PDCP PDU of the first plurality of PDCP PDUs, wherein the initial PDCP PDU of the second plurality of PDUs is received before any other PDCP PDU of the second plurality of PDUs;
decompress the initial PDCP PDU of the second plurality of PDCP PDUs to generate a decompressed initial PDCP SDU; and
set a serial number of the decompressed initial PDCP SDU.

36. The first network node of claim 35, wherein the serial number of the decompressed initial PDCP SDU corresponds to a serial number subsequent to a serial number of a last received PDCP SDU of the first plurality of PDCP SDUs before transmission of the UDC buffer error indication.

37. The first network node of claim 35, wherein the serial number of the decompressed initial PDCP SDU is an initial value of TX_NEXT.

38. The first network node of claim 24, wherein a serial number of an initial PDCP PDU of the second plurality of PDCP PDUs is the same as the serial number of the particular PDCP PDU of the first plurality of PDUs, wherein the initial PDCP PDU of the second plurality of PDUs is received before any other PDCP PDU of the second plurality of PDUs, and wherein the particular PDCP PDU processed by the first network node is a last processed PDCP PDU of the first plurality of PDCP PDUs.

39. The first network node of claim 24, wherein a serial number of an initial PDCP PDU of the second plurality of PDCP PDUs is the same as a serial number of a last received PDCP PDU of the first plurality of PDCP PDUs, wherein the initial PDCP PDU of the second plurality of PDCP PDUs is received before any other PDCP PDU of the second plurality of PDCP PDUs.

40. The first network node of claim 24, wherein a serial number of an initial PDCP PDU of the second plurality of PDCP PDUs is one value greater than a serial number of a last received PDCP PDU of the first plurality of PDCP PDUs, wherein the initial PDCP PDU of the second plurality of PDCP PDUs is received before any other PDCP PDU of the second plurality of PDCP PDUs.

41. The first network node of claim 24, wherein a serial number of an initial PDCP PDU of the second plurality of PDCP PDUs is one value greater than the serial number of the particular PDCP PDU of the first plurality of PDCP PDUs, wherein the particular PDCP PDU processed by the first network node is a last processed PDCP PDU of the first plurality of PDCP PDUs, wherein the initial PDCP PDU of the second plurality of PDCP PDUs is received before any other PDCP PDU of the second plurality of PDCP PDUs.

42. The first network node of claim 24, wherein a serial number of an initial PDCP PDU of the second plurality of PDCP PDUs is zero, wherein the initial PDCP PDU of the second plurality of PDCP PDUs is received before any other PDCP PDU of the second plurality of PDCP PDUs.

43. The first network node of claim 24, wherein the at least one processor is configured to:
resynchronize a decompression buffer of the first network node with a compression buffer of the second network node.
